(19) United States
(12) Patent Application Publication
(10) Pub. No.: US 2024/0192374 A1
(43) Pub. Date: Jun. 13, 2024

(54) DISTANCE IMAGE CAPTURING DEVICE AND DISTANCE IMAGE CAPTURING METHOD

(71) Applicant: TOPPAN Holdings Inc., Tokyo (JP)

(72) Inventors: Yasuyuki HITSUOKA, Tokyo (JP); Tomohiro NAKAGOME, Tokyo (JP); Kunihiro HATAKEYAMA, Tokyo (JP)

(73) Assignee: TOPPAN Holdings Inc., Tokyo (JP)

(21) Appl. No.: 18/529,401

(22) Filed: Dec. 5, 2023

(30) Foreign Application Priority Data
Dec. 7, 2022 (JP) 2022-195502
Oct. 25, 2023 (JP) 2023-183197

(51) Int. Cl. G01S 17/894; G01S 7/481; G01S 7/4865

(52) U.S. Cl. CPC G01S 17/894; G01S 7/4816; G01S 7/4865

(57) ABSTRACT

A distance image capturing device performs control such that a total number of times, which is a sum of times the charges are stored in each of the charge storage units in the one frame, and performs control such that a time difference between a first storage timing and a second storage timing is a time different from a storage time for storing the charges in each of the charge storage units, the first storage timing being a storage timing for storing the charges in a specific charge storage unit among the plurality of charge storage units in a specific storage cycle among the plurality of storage cycles, and the second storage timing being a storage timing for storing the charges in the specific charge storage unit in another storage cycle different from the specific storage cycle.

### BACKGROUND OF THE INVENTION

### Field of the Invention

The present invention relates to a distance image capturing device and a distance image capturing method.

Priority is claimed on Japanese Patent Application No. 2022-195502, filed on Dec. 7, 2022, and Japanese Patent Application No. 2023-183197, filed on Oct. 25, 2023, both contents of which are incorporated herein by reference.

### Description of Related Art

A time of flight (hereinafter, referred to as “TOF”) type distance image capturing device has been implemented that uses a known speed of light and measures a distance between a measuring instrument and an object, based on a flight time of light in a measurement space (for example, refer to Japanese Patent No. 6676866). In such a distance image capturing device, in order to widen a distance measurement range, a plurality of storage timings for storing charges in the same charge storage unit are provided. Since a plurality of storage timings are provided, the charges of the reflected light component can be stored at the earlier storage timing in a case where the distance to the object is close, and the charges of the reflected light component can be stored at the later storage timing in a case where the distance to the object is long. In this manner, it is possible to measure distances in a wide range from a short distance to a long distance.

### SUMMARY OF THE INVENTION

However, in Japanese Patent No. 6676866, in order to make the amount of charges of the background light component stored in all the charge storage units uniform, it is necessary to store the charges of the background light component in the charge storage units at a timing different from the measurable range. Therefore, there is a problem that a time required for measurement increases.

The present invention has been made based on the above problems, and an object of the present invention is to provide a distance image capturing device and a distance image capturing method capable of extending a measurable range without increasing a time required for measurement.

A distance image capturing device according to the present invention includes: a light source unit that irradiates a measurement space with a light pulse; a light receiving unit having a pixel including a photoelectric conversion element that generates charges according to incident light and a plurality of charge storage units that store the charges, and a pixel drive circuit that distributes the charges to the charge storage units and stores the charges in each of the charge storage units at a predetermined storage timing synchronized with an emission timing of emitting the light pulse; and a distance image processing unit that calculates a distance to an object existing in the measurement space, based on an amount of the charges stored in each of the charge storage units, wherein the distance image processing unit provides a plurality of storage cycles in one frame, performs control such that in the plurality of storage cycles, the charges are stored in each of the charge storage units at any timing among storage timings of which the number is larger than a number of the charge storage units included in the pixel, performs control such that a total number of times, which is a sum of times the charges are stored in each of the charge storage units in the one frame, and performs control such that a time difference between a first storage timing and a second storage timing is a time different from a storage time for storing the charges in each of the charge storage units, the first storage timing being a storage timing for storing the charges in a specific charge storage unit among the plurality of charge storage units in a specific storage cycle among the plurality of storage cycles, and the second storage timing being a storage timing for storing the charges in the specific charge storage unit in another storage cycle different from the specific storage cycle.

In the distance image capturing device according to the present invention, the distance image processing unit performs control such that a total time at which the charges are stored in the one frame is larger at the storage timings with a larger difference from the emission timing than the storage timings with a smaller difference.

A distance image capturing method according to the present invention is performed by a distance image capturing device including a light source unit that irradiates a measurement space with a light pulse, a light receiving unit having a pixel including a photoelectric conversion element that generates charges according to incident light and a plurality of charge storage units that store the charges, and a pixel drive circuit that distributes the charges to the charge storage units and stores the charges in each of the charge storage units at a predetermined storage timing synchronized with an emission timing of emitting the light pulse, and a distance image processing unit that calculates a distance to an object existing in the measurement space, based on an amount of the charges stored in each of the charge storage units, the method including: via the distance image processing unit providing a plurality of storage cycles in one frame; performing control such that in the plurality of storage cycles, the charges are stored in each of the charge storage units at any timing among storage timings of which the number is larger than a number of the charge storage units included in the pixel; performing control such that a total number of times, which is a sum of times the charges are stored in each of the charge storage units in the one frame; and performing control such that a time difference between a first storage timing and a second storage timing is a time different from a storage time for storing the charges in each of the charge storage units, the first storage timing being a storage timing for storing the charges in a specific charge storage unit among the plurality of charge storage units in a specific storage cycle among the plurality of storage cycles, and the second storage timing being a storage timing for storing the charges in the specific charge storage unit in another storage cycle different from the specific storage cycle.

According to the present invention, a measurable range can be extended without increasing a time required for measurement.

### BRIEF DESCRIPTION OF THE DRAWINGS

FIG. 1 is a block diagram showing a schematic configuration of a distance image capturing device 1 according to an embodiment.

FIG. 2 is a block diagram showing a schematic configuration of a distance image sensor 32 according to the embodiment.

FIG. 3 is a circuit diagram showing an example of a configuration of a pixel 321 according to the embodiment.

FIG. 4 is a timing chart showing a timing for driving the pixel 321 according to the first embodiment.

FIG. 5 is a timing chart showing a timing for driving a pixel 321 according to the first embodiment.

FIG. 6 is a timing chart showing a timing for driving the pixel 321 according to the first embodiment.

FIG. 7 is a diagram for describing a process performed by a distance image processing unit 4 according to the first embodiment.

FIG. 8 is a flowchart showing a flow of the process performed by the distance image processing unit 4 according to the first embodiment.

FIG. 9 is a timing chart showing a timing for driving the pixel 321 according to the first embodiment.

FIG. 10 is a timing chart showing a timing for driving the pixel 321 according to the first embodiment.

FIG. 11 is a timing chart showing a timing for driving the pixel 321 according to the first embodiment.

FIG. 12 is a diagram for describing a process performed by the distance image processing unit 4 according to the first embodiment.

FIG. 13 is a timing chart showing a timing for driving a pixel 321 according to a modification example of the first embodiment.

FIG. 14 is a timing chart showing a timing for driving the pixel 321 according to the modification example of the first embodiment.

FIG. 15 is a timing chart showing a timing for driving the pixel 321 according to the modification example of the first embodiment.

FIG. 16 is a timing chart showing a timing for driving the pixel 321 according to the modification example of the first embodiment.

FIG. 17 is a timing chart showing a timing for driving the pixel 321 according to the modification example of the first embodiment.

### DETAILED DESCRIPTION OF THE INVENTION

Hereinafter, a distance image capturing device according to the embodiment will be described with reference to the drawings.

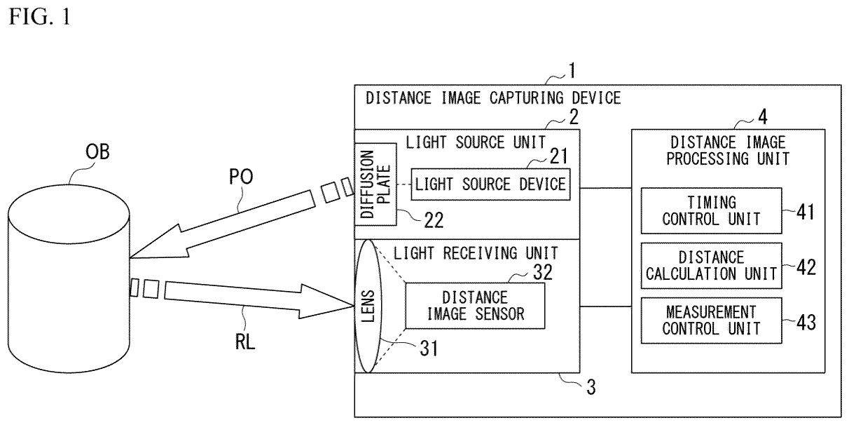

FIG. 1 is a block diagram showing a schematic configuration of the distance image capturing device according to the embodiment. A distance image capturing device 1 includes, for example, a light source unit 2, a light receiving unit 3, and a distance image processing unit 4. FIG. 1 also shows an object OB to which a distance is to be measured by the distance image capturing device 1.

The light source unit 2 emits an optical pulse PO to a space-to-be-measured in which the object OB to which a distance is to be measured by the distance image capturing device 1 exists, in accordance with the control from the distance image processing unit 4. The light source unit 2 is, for example, a surface emitting semiconductor laser module such as a vertical cavity surface emitting laser (VCSEL). The light source unit 2 includes a light source device 21 and a diffusion plate 22.

A light source device 21 is a light source that emits laser light in a near-infrared wavelength band (for example, a wavelength band with a wavelength of 850 nm to 940 nm) as the optical pulse PO that emits the object OB. The light source device 21 is, for example, a semiconductor laser light emitting element. The light source device 21 emits pulsed laser light in accordance with the control of a timing control unit 41.

The diffusion plate 22 is an optical component that diffuses the laser light in the near-infrared wavelength band emitted by the light source device 21 into a desired irradiation region. The pulsed laser light diffused by the diffusion plate 22 is emitted as the optical pulse PO, and emitted into the object OB.

The light receiving unit 3 receives reflected light RL of the optical pulse PO reflected by the object OB to which a distance is to be measured by the distance image capturing device 1, and outputs a pixel signal corresponding to the received reflected light RL. The light receiving unit 3 includes a lens 31 and a distance image sensor 32. In the light receiving unit 3, a band-pass filter (not shown) may be provided between the lens 31 and the distance image sensor 32. The band-pass filter limits the bandwidth. For example, the band-pass filter emits components in a predetermined frequency band in the light incident on the lens 31 to the distance image sensor 32 and does not emit components not in the predetermined frequency band to the distance image sensor 32.

The lens 31 is an optical lens that guides the incident reflected light RL to the distance image sensor 32. The lens 31 emits the incident reflected light RL to the distance image sensor 32 side, and causes the pixels provided in the light-receiving region of the distance image sensor 32 to receive the light (light is input to the pixel).

The distance image sensor 32 is an image capturing element used in the distance image capturing device 1. The distance image sensor 32 includes a plurality of pixels in a two-dimensional light-receiving region. Each pixel of the distance image sensor 32 includes one photoelectric conversion element, a plurality of charge storage units corresponding to the one photoelectric conversion element, and a component that distributes charges to the charge storage units. That is, the pixel is an image capturing element having a distribution configuration in which the charges are distributed and stored to the plurality of charge storage units.

The distance image sensor 32 distributes the charges generated by the photoelectric conversion element to the charge storage units, according to control from the timing control unit 41. In addition, the distance image sensor 32 outputs a pixel signal corresponding to the amount of charges distributed to the charge storage units. In the distance image sensor 32, a plurality of pixels are arranged in a two-dimensional matrix, and a pixel signal for one frame corresponding to each of the pixels is output.

The distance image processing unit 4 controls the distance image capturing device 1, and calculates a distance to the object OB. The distance image processing unit 4 includes a timing control unit 41, a distance calculation unit 42, and a measurement control unit 43.

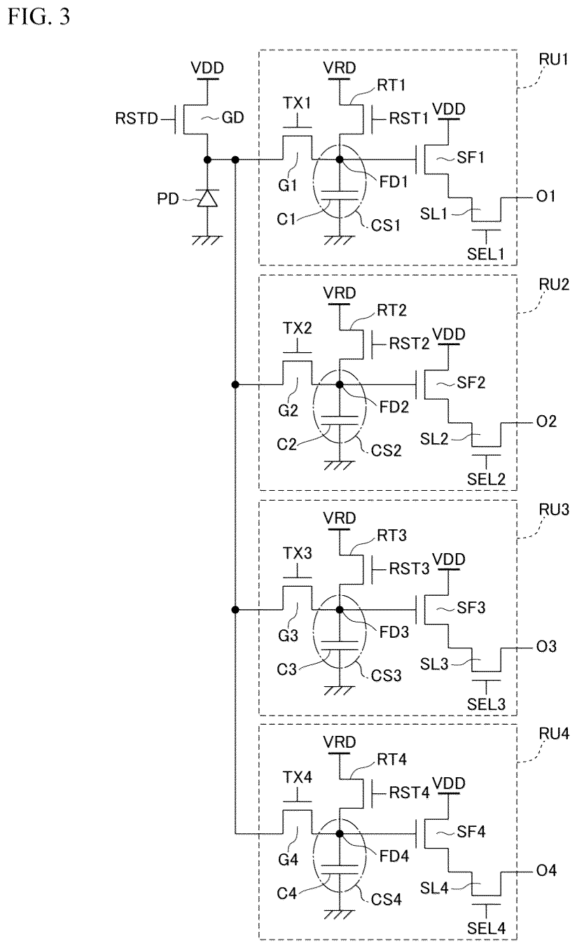

The timing control unit 41 controls the timing of outputting various control signals required for measurement in accordance with to the control of the measurement control unit 43. The various control signals here include, for example, a signal that controls the emission of the optical pulse PO, a signal that distributes the reflected light RL to the plurality of charge storage units and stores the reflected light RL, a signal that controls the number of storages per frame, and the like. The number of storages is the number of times the process of distributing and storing charges to the charge storage units CS (see FIG. 3) is repeated. The product of the number of storages and the time (storage time) for storing charges in each of the charge storage units per process of distributing and storing charges is the storage time.

The distance calculation unit 42 outputs distance information obtained by calculating the distance to the object OB, based on the pixel signal output from the distance image sensor 32. The distance calculation unit 42 calculates a delay time from emitting the optical pulse PO to receiving the reflected light RL, based on the amount of charges stored in the plurality of charge storage units. The distance calculation unit 42 calculates the distance to the object OB in accordance with the calculated delay time.

The measurement control unit 43 controls the timing control unit 41. For example, the measurement control unit 43 sets the number of storages and the storage time in one frame, and controls the timing control unit 41 such that an image is captured with the set contents.

With such a configuration, in the distance image capturing device 1, the light receiving unit 3 receives the reflected light RL in which the optical pulse PO in the near-infrared wavelength band emitted to the object OB by the light source unit 2 is reflected by the object OB, and the distance image processing unit 4 calculates the distance to the object OB and outputs the distance information.

Although FIG. 1 shows the distance image capturing device 1 having a configuration in which the distance image processing unit 4 is provided inside the distance image capturing device 1, the distance image processing unit 4 may be a component provided outside the distance image capturing device 1.

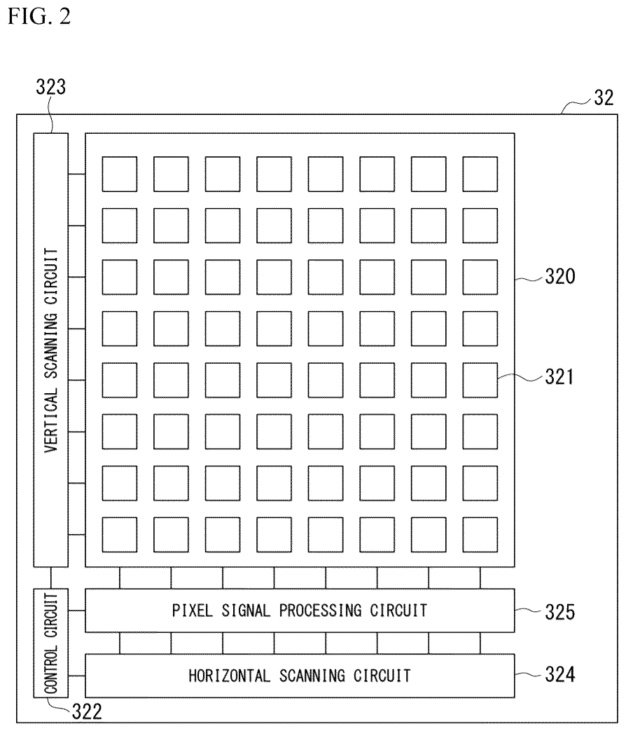

Here, the configuration of the distance image sensor 32 used as the image capturing element in the distance image capturing device 1 will be described with reference to FIG. 2. FIG. 2 is a block diagram showing a schematic configuration of the image capturing element (distance image sensor 32) used in the distance image capturing device 1 according to the embodiment.

As shown in FIG. 2, the distance image sensor 32 includes, for example, a light-receiving region 320 in which a plurality of pixels 321 are arranged, a control circuit 322, a vertical scanning circuit 323 performing a distribution operation, a horizontal scanning circuit 324, and a pixel signal processing circuit 325.

The light-receiving region 320 is a region in which a plurality of pixels 321 are arranged, and FIG. 2 shows an example in which the plurality of pixels 321 are arranged in a two-dimensional matrix in eight rows and eight columns. The pixels 321 store charges corresponding to the amount of light received. The control circuit 322 generally controls the distance image sensor 32. For example, the control circuit 322 controls the operations of the components of the distance image sensor 32 in response to an instruction from the timing control unit 41 of the distance image processing unit 4. Further, the components provided in the distance image sensor 32 may be controlled directly by the timing control unit 41, and in this case, the control circuit 322 can also be omitted.

The vertical scanning circuit 323 is a circuit that controls the pixels 321 arranged in the light-receiving region 320 for each row according to the control from the control circuit 322. The vertical scanning circuit 323 outputs a voltage signal corresponding to the amount of charges stored in each of the charge storage units CS of the pixel 321 to the pixel signal processing circuit 325. In such a case, the vertical scanning circuit 323 distributes and stores the charges converted by the photoelectric conversion element to the charge storage units of the pixel 321. That is, the vertical scanning circuit 323 is an example of a “pixel driving circuit”.

The pixel signal processing circuit 325 is a circuit that performs a predetermined signal process (for example, a noise suppression process, an A/D conversion process, or the like) on the voltage signal output to the corresponding vertical signal line from the pixel 321 in each of the columns in accordance with the control from the control circuit 322.

The horizontal scanning circuit 324 is a circuit that sequentially outputs the signals output from the pixel signal processing circuit 325 to the horizontal signal line in accordance with the control from the control circuit 322. Accordingly, a pixel signal corresponding to the amount of charges stored for one frame is sequentially output to the distance image processing unit 4 via the horizontal signal line.

Hereinafter, it is described that the pixel signal processing circuit 325 performs an A/D conversion process and the pixel signal is a digital signal.

Here, the configuration of the pixels 321 arranged in the light-receiving region 320 provided in the distance image sensor 32 will be described with reference to FIG. 3. FIG. 3 is a circuit diagram showing an example of a configuration of the pixels 321 arranged in the light-receiving region 320 of the distance image sensor 32 according to the embodiment. FIG. 3 shows an example of the configuration of one pixel 321 among the plurality of pixels 321 arranged in the light-receiving region 320. The pixel 321 is an example of a configuration including four pixel signal readout units.

The pixel 321 includes one photoelectric conversion element PD, a drain gate transistor GD, and four pixel signal readout units RU for outputting voltage signals from corresponding output terminals O. Each of the pixel signal readout units RU includes a readout gate transistor G, a floating diffusion FD, a charge storage capacitor C, a reset gate transistor RT, a source follower gate transistor SF, and a selection gate transistor SL. In each of the pixel signal readout units RU, the floating diffusion FD and the charge storage capacitor C configure the charge storage unit CS.

In FIG. 3, the pixel signal readout units RU are distinguished by adding a number “1”, “2” “3”, or “4” after the symbol “RU” of the four pixel signal readout units RU. In addition, similarly, for each component provided in each of the four pixel signal readout units RU, a number representing each pixel signal readout unit RU is added after the symbol to distinguish and represent the pixel signal readout unit RU corresponding to each component.

In the pixel 321 shown in FIG. 3, a pixel signal readout unit RU1 that outputs a voltage signal from an output terminal O1 includes a readout gate transistor G1, a floating diffusion FD1, a charge storage capacitor C1, a reset gate transistor RT1, a source follower gate transistor SF1, and a selection gate transistor SL1. In the pixel signal readout unit RU1, the charge storage unit CS1 is composed of the floating diffusion FD1 and the charge storage capacitor C1. Pixel signal readout units RU2 to RU4 also have the same configuration.

The photoelectric conversion element PD is an embedded photodiode that photoelectrically converts incident light to generate a charge and stores the generated charge. The photoelectric conversion element PD may have any structure. The photoelectric conversion element PD may be, for example, a PN photodiode having a structure in which a P-type semiconductor and an N-type semiconductor are joined together, or a PIN photodiode having a structure in which an I-type semiconductor is sandwiched between a P-type semiconductor and an N-type semiconductor.

In the pixel 321, the charges generated by photoelectric conversion of incident light by the photoelectric conversion element PD are distributed to four charge storage units CS, and each of the voltage signals corresponding to the charge amount of the distributed charges is output to the pixel signal processing circuit 325.

The configuration of the pixels arranged in the distance image sensor 32 is not limited to the configuration including the four pixel signal readout units RU as shown in FIG. 3, and may be any pixel of configuration as long as it includes a plurality of pixel signal readout units RU. That is, the number of pixel signal readout units RU (charge storage units CS) provided in the pixels arranged in the distance image sensor 32 may be two, three, or five or more.

In addition, in the pixel 321 having the configuration shown in FIG. 3, an example in which the charge storage unit CS includes a floating diffusion FD and a charge storage capacitor C is shown. However, the charge storage unit CS may include at least the floating diffusion FD, and the pixel 321 may not include the charge storage capacitor C.

In addition, in the pixel 321 having the configuration shown in FIG. 3, although an example of the configuration including the drain gate transistor GD is shown, when it is not necessary to discard the charges stored (remaining) in the photoelectric conversion element PD, the drain gate transistor GD may not be provided.

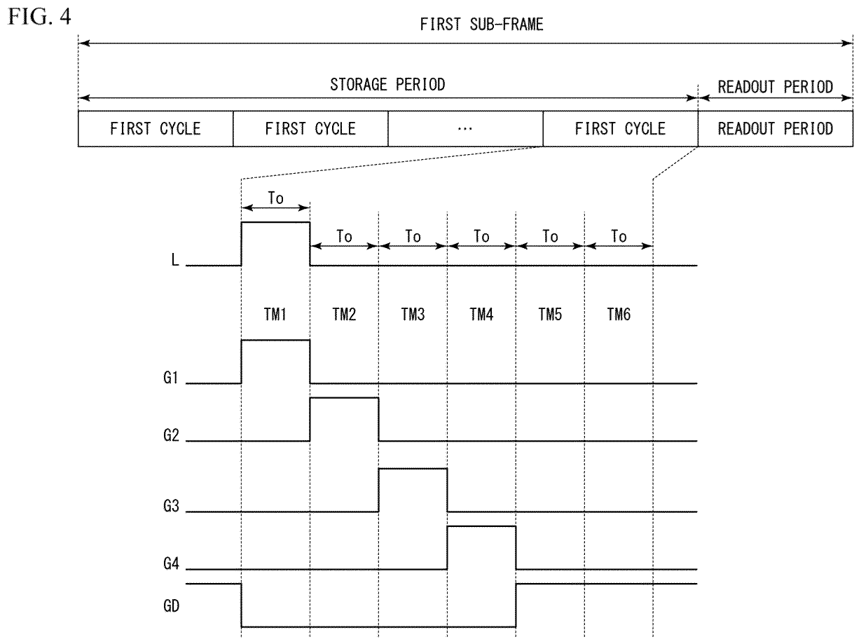

Here, the timing for driving the pixel 321 will be described using FIGS. 4 to 6. FIGS. 4 to 6 are timing charts showing timings for driving the pixel 321 according to the first embodiment.

In the present embodiment, a plurality of sub-frames are provided in one frame. In the following description, a case where one frame includes three sub-frames of a first sub-frame, a second sub-frame, and a third sub-frame will be described as an example. However, the number of sub-frames included in one frame may be two, or four or more.

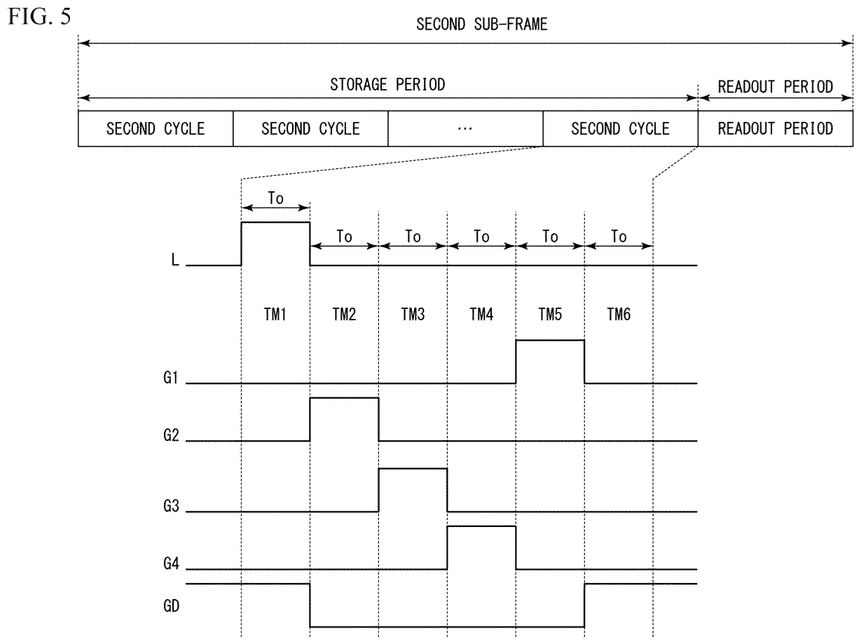

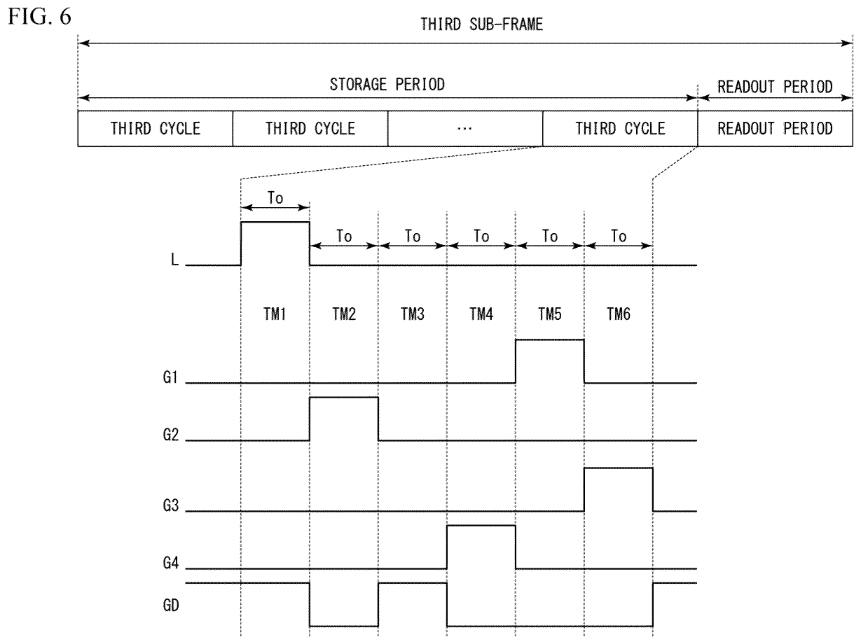

FIG. 4 shows a timing chart showing the timing for driving the pixel 321 in the first sub-frame. FIG. 5 shows a timing chart showing a timing for driving the pixel 321 in the second sub-frame. FIG. 6 shows a timing chart showing the timing for driving the pixel 321 in the third sub-frame.

The timing signals of FIGS. 4 to 6 will be described. The emission timing for emitting the optical pulse PO is indicated by “L”. In addition, “G1” indicates a storage timing for storing the charges in the charge storage unit CS1 by a drive signal TX1 (the timing for controlling the opening and closing of the readout gate transistor G1). Similarly. “G2-G4” indicates storage timings for storing the charges in the charge storage units CS2 to CS4 by drive signals TX2 to TX4 (timings of controlling the opening and closing of the readout gate transistors G2 to G4). “GD” indicates the discharge timing for discharging the charges by a drive signal RSTD.

The signal logic in the timing charts of FIGS. 4 to 6 will be described. Each timing signal is indicated with a “high” level or a “low” level. At the emission timing L, the optical pulse PO is emitted at the timing of the “high” level, and the optical pulse PO is not emitted in the case of the “low” level. At the storage timings G1 to G4, charges are stored at the timing of “high” and charges are not stored at the timing of “low”. At the discharge timing GD, the charges are discharged at the timing of “high” and the charges are not discharged at the timing of “low”.

As shown in FIGS. 4 to 6, each sub-frame is provided with a storage period and a readout period. The pixel 321 is driven during the storage period, and the cycle (storage cycle) of storing charges in each of the plurality of charge storage units CS (charge storage units CS1 to CS4) provided in the pixel 321 is repeated a predetermined number of times, for example, 10,000 times. In the readout period, the storage signal corresponding to the amount of charges stored in each of the charge storage units CS is read out.

As shown in FIGS. 4 to 6, the distance image processing unit 4 stores the charges in any of the charge storage units CS at any of the six storage timings TM1 to TM6 during the storage period of each sub-frame.

The storage timing TM1 has a delay time of 0 (zero) from the emission timing L for emitting the optical pulse PO, and is the same timing as the emission timing of the optical pulse PO. The storage timing TM2 is a timing at which the delay time from the emission timing L for emitting the optical pulse PO is the time To. Here, the time To is an emission time for emitting the optical pulse PO. In addition, here, it is premised that the storage time for storing the charges is the same as the emission time, that is, the storage time is the time To.

The storage timing TM2 is a timing at which the delay time from the emission timing L for emitting the optical pulse PO is the time To. The storage timing TM3 is a timing at which the delay time from the emission timing L for emitting the optical pulse PO is the time To×2. The storage timing TM4 is a timing at which the delay time from the emission timing L for emitting the optical pulse PO is the time To×3. The storage timing TM5 is a timing at which the delay time from the emission timing L for emitting the optical pulse PO is the time To×4. The storage timing TM6 is a timing at which the delay time from the emission timing L for emitting the optical pulse PO is the time To×5.

FIG. 4 shows an example in which the first cycle is repeated in the storage period of the first sub-frame. In the first cycle, an example is shown in which the charges are sequentially stored in the charge storage units CS1 to CS4 at the storage timings TM1 to TM4, respectively. Accordingly, it is possible to store the charges corresponding to the reflected light RL received at any timing of the storage timings TM1 to TM4. In this case, it is possible to measure the distance to the object OB in a case where the charges corresponding to the reflected light RL are stored across the storage timings TM1 to TM2, the storage timings TM2 to TM3, and the storage timings TM3 to TM4.

FIG. 5 shows an example in which the second cycle is repeated in the storage period of the second sub-frame. In the second cycle, an example is shown in which the charges are sequentially stored in the charge storage units CS2, CS3, CS4, and CS1 at the storage timings TM2 to TM5, respectively. Accordingly, it is possible to store the charges corresponding to the reflected light RL received at any timing of the storage timings TM2 to TM5. In this case, it is possible to measure the distance to the object OB in a case where the charges corresponding to the reflected light RL are stored across the storage timings TM2 to TM3, the storage timings TM3 to TM4, and the storage timings TM4 to TM5. That is, it is possible to measure a distance to the object OB existing farther than in the case of the first sub-frame.

FIG. 6 shows an example in which the third cycle is repeated in the storage period of the third sub-frame. In the third cycle, an example is shown in which charges are sequentially stored in the charge storage units CS2, CS4, CS1, and CS3 at the storage timings TM2, TM4 to TM6. Accordingly, it is possible to store the charges corresponding to the reflected light RL received at any timing of the storage timings TM2, and TM4 to TM6. In this case, it is possible to measure the distance to the object OB in a case where the charges corresponding to the reflected light RL are stored across the storage timings TM4 to TM5 and the storage timings TM5 and TM6. That is, it is possible to measure a distance to the object OB existing farther than in the case of the first sub-frame and the second sub-frame.

In this manner, the distance image processing unit 4 stores the charges in any of the charge storage units CS at any of the storage timings TM1 to TM6 in each sub-frame. Accordingly, it is possible to store the charges corresponding to the reflected light RL from the object OB existing at a long distance. Therefore, the measurable distance can be enlarged.

In addition, the distance image processing unit 4 performs control such that the total number of storages in which the charges are stored in each of the charge storage units CS is the same in one frame. For example, the distance image processing unit 4 stores the charges once in each of the charge storage units CS1 to CS4 in each sub-frame, and performs control such that the total number of storages in one frame is three, which is the same in all of the charge storage units CS1 to CS4.

Alternatively, the distance image processing unit 4 stores charges two times in the charge storage unit CS1 and once in each of the charge storage units CS2 to CS4 in the first sub-frame, stores charges 0 times in the charge storage unit CS1 and once in each of the charge storage units CS2 to CS4 in the second sub-frame, and stores charges once in each of the charge storage units CS1 to CS4 in the third sub-frame. In this manner, the distance image processing unit 4 performs control such that the total number of storages in one frame is three in all of the charge storage units CS1 to CS4.

In this manner, by performing control such that the total number of storages in each of the charge storage units CS is the same in one frame, the distance image processing unit 4 makes the amount of charges corresponding to the background light component stored in each charge storage unit CS to be the same amount. Accordingly, it is possible to easily specify the charge storage unit CS in which the charges corresponding to the reflected light RL are stored.

Further, the distance image processing unit 4 performs control such that the time difference between the timings of storing charges in a specific charge storage unit CS does not become the storage time (here, time To) in each sub-frame.

Specifically, a control is performed such that the time difference between the first storage timing for storing the charges in the charge storage unit CS1 in the first sub-frame and the second storage timing for storing the charges in the charge storage unit CS1 in the second sub-frame does not become the storage time. Further, a control is performed such that the time difference between the first storage timing and the third storage timing for storing the charges in the charge storage unit CS1 in the third sub-frame does not become the storage time. Further, a control is performed such that the time difference between the second storage timing and the third storage timing becomes a time different from the storage time To.

Similarly, for the other charge storage unit CS other than the charge storage unit CS1, a control is performed such that the time difference between the first storage timing for storing the charges in the charge storage unit CS2 (or the charge storage unit CS3 or CS4) in the first sub-frame and the second storage timing for storing the charges in the charge storage unit CS2 (or the charge storage unit CS3 or CS4) in the second sub-frame becomes a time different from the storage time To. Further, a control is performed such that the time difference between the first storage timing and the third storage timing for storing the charges in the charge storage unit CS2 (or the charge storage unit CS3 or CS4) in the third sub-frame becomes a time different from the storage time To. Further, a control is performed such that the time difference between the second storage timing and the third storage timing becomes a time different from the storage time To.

By performing such control, in a case where a part (the first half portion) of the charges corresponding to the reflected light RL is stored in a specific charge storage unit CS in a specific sub-frame, the distance image processing unit 4 can prevent the remaining part (second half portion) of the charges corresponding to the reflected light RL from being stored in the same specific charge storage unit CS in other sub-frames. This allows not only the measurement closed in each sub-frame, that is, the measurement of the distance using only the amount of charges stored in each sub-frame, but also the distance calculation by combining the amount of charges stored in each of the plurality of sub-frames.

For example, as shown in FIG. 4, in a case where the charges are stored in the charge storage unit CS1 at the storage timing TM1 in the first sub-frame, the distance image processing unit 4 stores the charges in the charge storage unit CS1 at a timing other than the storage timing TM2 in the second and third sub-frames. FIG. 5 shows an example in which charges are stored in the charge storage unit CS1 at the storage timing TM5 in the second sub-frame. FIG. 6 shows an example in which charges are stored in the charge storage unit CS1 at the storage timing TM5 in the third sub-frame.

In this manner, in a case where the charges are stored in the charge storage unit CS1 at the storage timing TM1 in the first sub-frame, the charges may be stored in the charge storage unit CS1 at least at a timing other than the storage timing TM2 in other sub-frames, or the charges may be stored in the charge storage unit CS1 at the same storage timing in a plurality of sub-frames.

Further, as shown in FIG. 4, when the charges are stored in the charge storage unit CS2 at the storage timing TM2 in the first sub-frame, the distance image processing unit 4 stores the charges in the charge storage unit CS2 at a timing other than the storage timings TM1 and TM3 in the second and third sub-frames. FIG. 5 shows an example in which charges are stored in the charge storage unit CS2 at the storage timing TM2 in the second sub-frame. FIG. 6 shows an example in which charges are stored in the charge storage unit CS2 at the storage timing TM2 in the second sub-frame.

In this manner, in a case where the charges are stored in the charge storage unit CS2 at the storage timing TM2 in the first sub-frame, the charges may be stored in the charge storage unit CS2 at least at a timing other than the storage timings TM1 and TM3 in other sub-frames. For example, the charges may be stored in the charge storage unit CS2 at the same storage timing TM2 in all sub-frames.

Further, as shown in FIG. 4, when the charges are stored in the charge storage unit CS3 at the storage timing TM3 in the first sub-frame, the distance image processing unit 4 stores the charges in the charge storage unit CS3 at a timing other than the storage timings TM2 and TM4 in the second and third sub-frames. FIG. 5 shows an example in which charges are stored in the charge storage unit CS3 at the storage timing TM3 in the second sub-frame. FIG. 6 shows an example in which charges are stored in the charge storage unit CS3 at the storage timing TM6 in the second sub-frame.

In this manner, in a case where the charges are stored in the charge storage unit CS3 at the storage timing TM3 in the first sub-frame, the charges may be stored in the charge storage unit CS3 at least at a timing other than the storage timings TM2 and TM4 in other sub-frames. For example, in one of the other sub-frames, charges are stored in the charge storage unit CS3 at the same storage timing TM3 as in the first sub-frame, and charges may be stored in the charge storage unit CS3 at a storage timing TM6 which is different from in the first sub-frame and is not the storage timings TM2 and TM4.

Further, as shown in FIG. 4, when the charges are stored in the charge storage unit CS4 at the storage timing TM4 in the first sub-frame, the distance image processing unit 4 stores the charges in the charge storage unit CS4 at a timing other than the storage timings TM3 and TM5 in the second and third sub-frames. FIG. 5 shows an example in which charges are stored in the charge storage unit CS4 at the storage timing TM4 in the second sub-frame. FIG. 6 shows an example in which charges are stored in the charge storage unit CS4 at the storage timing TM4 in the second sub-frame.

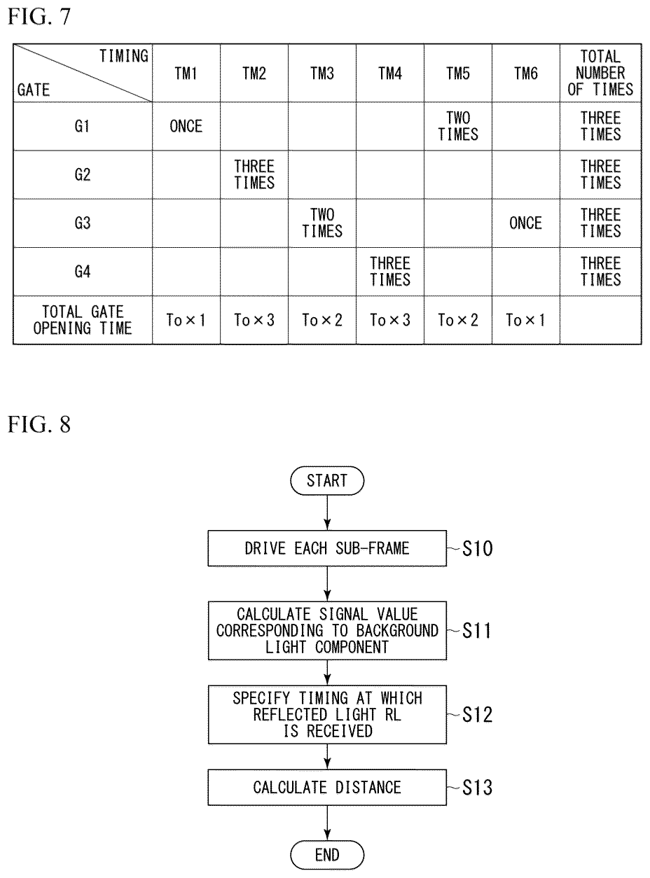

Here, a method in which the distance image processing unit 4 calculates the distance will be described using FIGS. 7 and 8. FIG. 7 is a diagram for describing a process performed by the distance image processing unit 4 according to the first embodiment. FIG. 8 is a flowchart showing a flow of the process performed by the distance image processing unit 4 according to the embodiment.

In the vertical direction of FIG. 7, readout gate transistors G1 to G4 corresponding to “gate”, that is, each of the charge storage units CS1 to CS4 is shown. In the horizontal direction of FIG. 7, “timing”, that is, each of the storage timings TM1 to TM6 is shown. FIG. 7 shows the number of times charges are stored in the storage timings in the horizontal direction, for each “gate” in the vertical direction in one frame.

Specifically, it is shown that in the gate G1, that is, the charge storage unit CS1, the charges are stored “once” at the storage timing TM1 and “two times” at the storage timing TM5. It is shown that in the gate G2, that is, the charge storage unit CS2, the charges are stored “three times” at the storage timing TM2. It is shown that in the gate G3, that is, the charge storage unit CS3, the charges are stored “two times” at the storage timing TM3 and “once” at the storage timing TM6. It is shown that in the gate G4, that is, the charge storage unit CS4, the charges are stored “three times” at the storage timing TM4.

Further, FIG. 7 shows the total number of times that charges are stored in one frame, for each “gate” in the vertical direction. Specifically, it is shown that the total number of times is the same “three times” in the gates G1 to G4, that is, all of the charge storage units CS1 to CS4.

Further, FIG. 7 shows a total time (total gate opening time) during which charges are stored in one frame, for each “timing” in the horizontal direction.

Specifically, it is shown that the total time during which the charges are stored at the storage timing TM1 is time To×1. It is shown that the total time during which the charges are stored is time To×3 at the storage timing TM2. It is shown that the total time during which the charges are stored is time To×2 at the storage timing TM3. It is shown that the total time during which the charges are stored is time To×3 at the storage timing TM4. It is shown that the total time during which the charges are stored is time To×2 at the storage timing TM5. It is shown that the total time during which the charges are stored is time To×1 at the storage timing TM6.

As shown in FIG. 8, first, the distance image processing unit 4 drives the pixel 321 at the timing of each sub-frame (step S10). The distance image processing unit 4 stores charges in each of the charge storage units CS during the storage period of each sub-frame, and reads out storage signals SIG1 to SIG4 corresponding to the amount of charges stored in respective charge storage units CS during the readout period. The distance image processing unit 4 stores the read storage signals SIG1 to SIG4 in the buffer.

Next, the distance image processing unit 4 calculates a signal value corresponding to the background light component (step S11). For example, the distance image processing unit 4 calculates the signal value SIGH corresponding to the background light component by using Equation (1).

SIGH=MIN(ΣSIG1,ΣSIG2,ΣSIG3,ΣSIG4)/N (1)
where:

SIGH is a signal value corresponding to a background light component.

ΣSIG1 is a total value of SIG1 in one frame. SIG1 is a signal value corresponding to the amount of charges stored in the charge storage unit CS1 in each sub-frame.

ΣSIG2 is a total value of SIG2 in one frame. SIG2 is a signal value corresponding to the amount of charges stored in the charge storage unit CS2 in each sub-frame.

ΣSIG3 is a total value of SIG3 in one frame. SIG3 is a signal value corresponding to the amount of charges stored in the charge storage unit CS3 in each sub-frame.

|SIG4 is a total value of SIG4 in one frame. SIG4 is a signal value corresponding to the amount of charges stored in the charge storage unit CS4 in each sub-frame.

N is the number of sub-frames included in one frame.

For example, in a case where one frame includes three sub-frames from the first sub-frame to the third sub-frame, N=3.

Next, the distance image processing unit 4 specifies the timing at which the reflected light RL is received (step S12). For example, the distance image processing unit 4 specifies two consecutive storage timings TM at which the signal value calculated in (1) (signal value corresponding to the background light component) from the storage signals at the storage timings TM1 to TM6 is equal to or higher than the threshold value, as the timings at which the reflected light RL is received.

As shown in FIG. 7, the total time during which the charges are stored at the storage timing TM1 is To×1, and as shown in FIGS. 4 to 6, the charges are stored in the charge storage unit CS1 at the storage timing TM1 in the first sub-frame. In this case, in a case where a difference between the storage signal SIG1 of the first sub-frame and the signal value SIGH corresponding to the background light component calculated using Equation (1) is greater than or equal to the threshold value, the distance image processing unit 4 determines that there is a possibility that the reflected light RL is received at the storage timing TM1. On the other hand, in a case where the difference is less than the threshold value, the distance image processing unit 4 determines that there is no possibility that the reflected light RL has been received at the storage timing TM1.

Further, as shown in FIG. 7, the total time during which the charges are stored at the storage timing TM2 is To×3, and as shown in FIGS. 4 to 6, the charges are stored in the charge storage unit CS2 at the storage timing TM2 in each sub-frame. In this case, in a case where a difference between the storage signal SIG2 of any sub-frame and the signal value SIGH corresponding to the background light component calculated using Equation (1) is greater than or equal to the threshold value, the distance image processing unit 4 determines that there is a possibility that the reflected light RL is received at the storage timing TM2. On the other hand, in a case where the difference is less than the threshold value, the distance image processing unit 4 determines that there is no possibility that the reflected light RL has been received at the storage timing TM2.

Further, as shown in FIG. 7, the total time during which the charges are stored at the storage timing TM3 is To×2, and as shown in FIGS. 4 to 6, the charges are stored in the charge storage unit CS3 at the storage timing TM3 in the first sub-frame and the second sub-frame. In this case, in a case where a difference between the storage signal SIG3 of the first sub-frame or the second sub-frame and the signal value SIGH corresponding to the background light component calculated using Equation (1) is greater than or equal to the threshold value, the distance image processing unit 4 determines that there is a possibility that the reflected light RL is received at the storage timing TM3. On the other hand, in a case where the difference is less than the threshold value, the distance image processing unit 4 determines that there is no possibility that the reflected light RL has been received at the storage timing TM3.

Further, as shown in FIG. 7, the total time during which the charges are stored at the storage timing TM4 is To×3, and as shown in FIGS. 4 to 6, the charges are stored in the charge storage unit CS4 at the storage timing TM4 in each sub-frame. In this case, in a case where a difference between the storage signal SIG4 of any sub-frame and the signal value SIGH corresponding to the background light component calculated using Equation (1) is greater than or equal to the threshold value, the distance image processing unit 4 determines that there is a possibility that the reflected light RL is received at the storage timing TM4. On the other hand, in a case where the difference is less than the threshold value, the distance image processing unit 4 determines that there is no possibility that the reflected light RL has been received at the storage timing TM4.

Further, as shown in FIG. 7, the total time during which the charges are stored at the storage timing TM5 is To×2, and as shown in FIGS. 4 to 6, the charges are stored in the charge storage unit CS1 at the storage timing TM5 in the second sub-frame and the third sub-frame. In this case, in a case where a difference between the storage signal SIG1 of the second sub-frame or the third sub-frame and the signal value SIGH corresponding to the background light component calculated using Equation (1) is greater than or equal to the threshold value, the distance image processing unit 4 determines that there is a possibility that the reflected light RL is received at the storage timing TM5. On the other hand, in a case where the difference is less than the threshold value, the distance image processing unit 4 determines that there is no possibility that the reflected light RL has been received at the storage timing TM5.

Further, as shown in FIG. 7, the total time during which the charges are stored at the storage timing TM6 is To×1, and as shown in FIGS. 4 to 6, the charges are stored in the charge storage unit CS3 at the storage timing TM6 in the third sub-frame. In this case, in a case where a difference between the storage signal SIG3 of the third sub-frame and the signal value SIGH corresponding to the background light component calculated using Equation (1) is greater than or equal to the threshold value, the distance image processing unit 4 determines that there is a possibility that the reflected light RL is received at the storage timing TM6. On the other hand, in a case where the difference is less than the threshold value, the distance image processing unit 4 determines that there is no possibility that the reflected light RL has been received at the storage timing TM6.

In this manner, the distance image processing unit 4 determines whether or not there is a possibility that the reflected light RL has been received at each of the storage timings TM1 to TM6. In a case where there are two storage timings at which the reflected light RL may have been received and the two storage timings are consecutive, the distance image processing unit 4 specifies the two storage timings as timings at which the reflected light RL has been received.

In a case where two consecutive storage timings at which the reflected light RL is received can be specified, the distance image processing unit 4 calculates storage signals SIGQ1 and SIGQ2 corresponding to the amount of charges stored at the two consecutive storage timings TM at which the reflected light RL is received. Here, the storage signal SIGQ1 is a storage signal including the first half portion of the reflected light RL. The storage signal SIGQ2 is a storage signal including the second half portion of the reflected light RL.

For example, in a case where two consecutive storage timings at which the reflected light RL is received are the storage timings TM1 and TM2, the storage signal SIG1 of the first sub-frame is set as the storage signal SIGQ1. Further, the storage signal SIG2 in any sub-frame is set as a storage signal SIGQ2.

For example, in a case where two consecutive storage timings at which the reflected light RL is received are the storage timings TM2 and TM3, the storage signal SIG2 in any sub-frame is set as the storage signal SIGQ1. In addition, the storage signal SIG3 in the first sub-frame or the second sub-frame is set as the storage signal SIGQ2.

For example, in a case where the two consecutive storage timings at which the reflected light RL is received are the storage timings TM3 and TM4, the storage signal SIG3 in the first sub-frame or the second sub-frame is set as the storage signal SIGQ1. In addition, the storage signal SIG4 in any sub-frame is set as the storage signal SIGQ2.

For example, in a case where two consecutive storage timings at which the reflected light RL is received are the storage timings TM4 and TM5, the storage signal SIG4 in any sub-frame is set as the storage signal SIGQ1. In addition, the storage signal SIG1 of the second sub-frame or the third sub-frame is set as the storage signal SIGQ2.

For example, in a case where the two consecutive storage timings at which the reflected light RL is received are the storage timings TM5 and TM6, the storage signal SIG1 of the second sub-frame or the third sub-frame is set as the storage signal SIGQ1. In addition, the storage signal SIG3 of the third sub-frame is set as the storage signal SIGQ2.

Next, the distance image processing unit 4 calculates the distance to the object OB (step S13). For example, in a case where the reflected light RL is received at the storage timings TM1 and TM2, the distance image processing unit 4 calculates the distance d to the object OB using Equation (2).

d=c0×(1/2×Td)

Td=To×(SIGQ2−SIGH)/(SIGQ1+SIGQ2−2×SIGH) (2)

where:

d is the distance to the object OB.

c0 is the speed of light.

Td is the time required for the light to reach the object OB.

SIGQ1 is a storage signal corresponding to the first half portion of the reflected light RL.

SIGQ2 is a storage signal corresponding to the second half portion of the reflected light RL.

SIGH is a storage signal corresponding to the background light component.

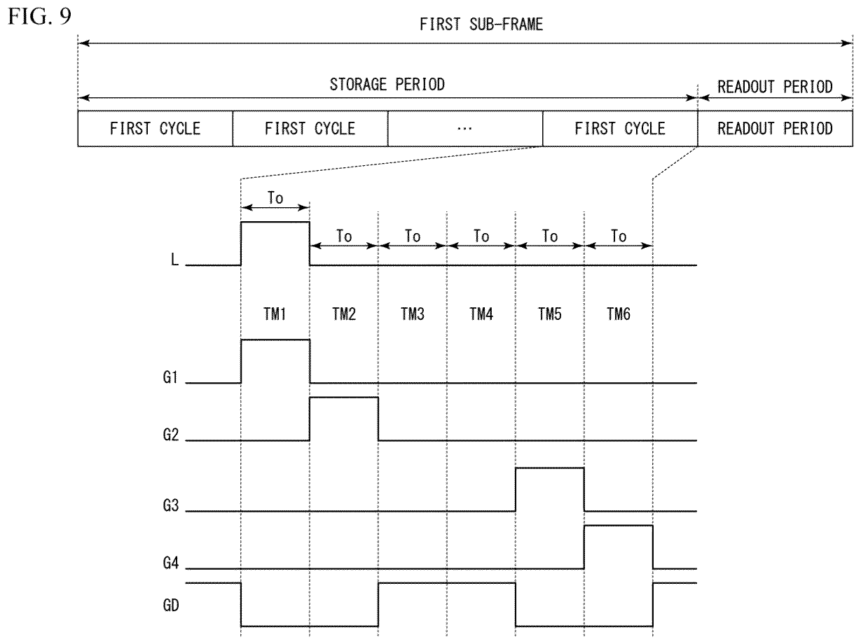

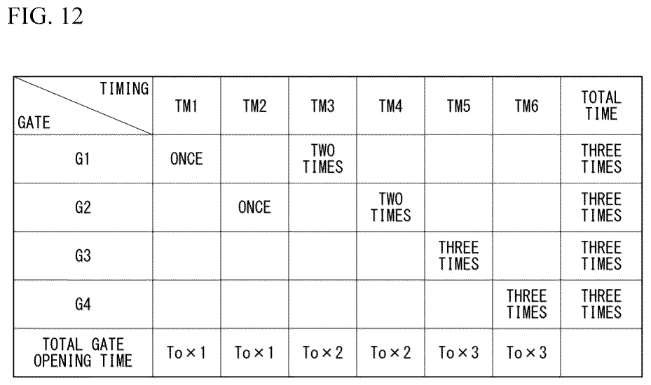

Here, the timings for driving the pixel 321 will be described using FIGS. 9 to 12. FIGS. 9 to 11 are timing charts showing timings for driving the pixel 321 according to the first embodiment. FIG. 12 is a diagram for describing a process performed by the distance image processing unit 4 according to the first embodiment.

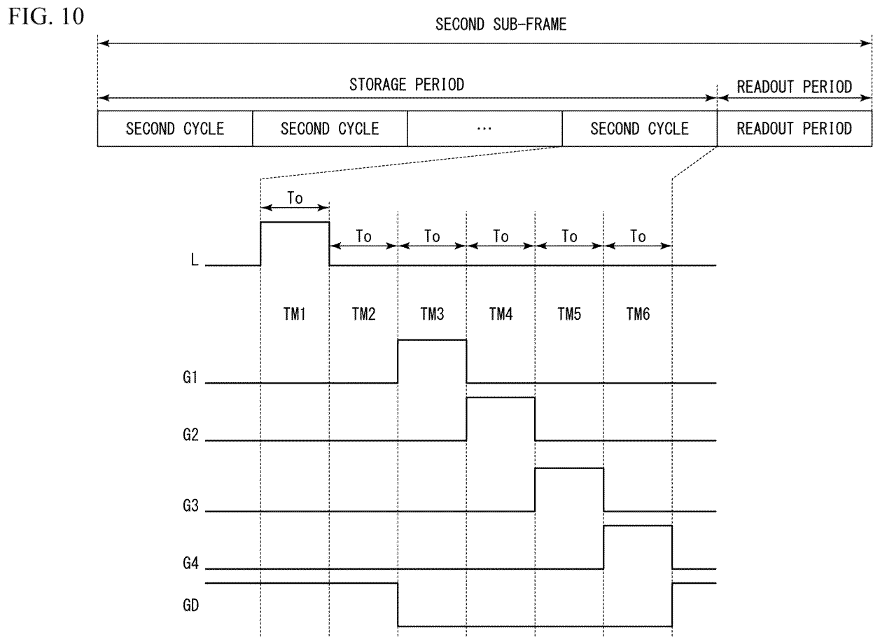

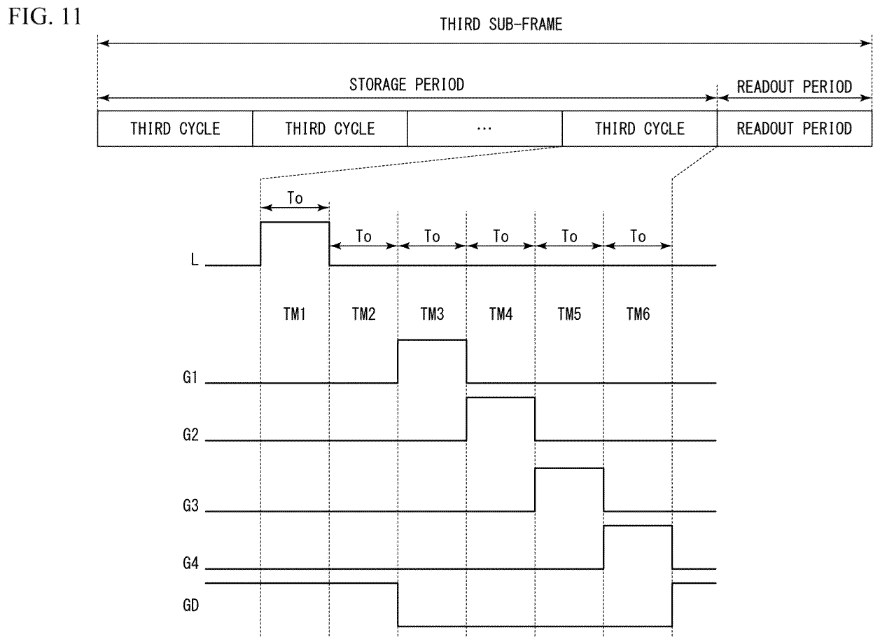

The timing charts showing the timings for driving the pixel 321 in the first sub-frame, the second sub-frame, and the third sub-frame are shown in FIG. 9, FIG. 10, and FIG. 11, respectively. The signal names and signal logics of FIGS. 9 to 10 are the same as those of FIGS. 4 to 6.

FIG. 9 shows an example in which the first cycle is repeated in the storage period of the first sub-frame. An example is shown in which in the first cycle, charges are stored in the charge storage unit CS1 at the storage timing TM1, in the charge storage unit CS2 at the storage timing TM2, in the charge storage unit CS3 at the storage timing TM5, and in the charge storage unit CS4 at the storage timing TM6, respectively.

FIG. 10 shows an example in which the second cycle is repeated in the storage period of the second sub-frame. An example is shown in which in the second cycle, charges are stored in the charge storage unit CS1 at the storage timing TM3, in the charge storage unit CS2 at the storage timing TM4, in the charge storage unit CS3 at the storage timing TM5, and in the charge storage unit CS4 at the storage timing TM6, respectively.

FIG. 11 shows an example in which the third cycle is repeated in the storage period of the third sub-frame. An example is shown in which similarly to the second cycle, in the third cycle, charges are stored in the charge storage unit CS1 at the storage timing TM3, in the charge storage unit CS2 at the storage timing TM4, in the charge storage unit CS3 at the storage timing TM5, and in the charge storage unit CS4 at the storage timing TM6, respectively.

FIG. 12 shows a relationship between “gate” and “timing” in a frame corresponding to FIGS. 9 to 11. The “gate” and the “timing” in FIG. 12 are the same as in FIG. 7.

Further, FIG. 12 shows a total time (total gate opening time) during which charges are stored in one frame, for each “timing” in the horizontal direction.

Specifically, it is shown that the total time during which the charges are stored at the storage timings TM1 and TM2 is time To×1. It is shown that the total time during which the charges are stored at the storage timings TM3 and TM4 is time To×2. It is shown that the total time during which the charges are stored at the storage timings TM5 and TM6 is time To×3.

In this manner, the distance image processing unit 4 performs control such that the total time at which charges are stored in one frame is larger at the storage timings TM3 and TM4 with a larger difference from the emission timing L than the storage timings TM1 and TM2 with a smaller difference, at each of the plurality of storage timings TM1 to TM6. Further, it is controlled such that the total time at which charges are stored in one frame is larger at the storage timings TM5 and TM6 with a larger difference from the emission timing L than the storage timings TM3 and TM4 with a smaller difference.

Generally, the smaller the distance to the object OB, the greater the intensity of the reflected light RL. That is, the intensity of the reflected light RL received at the storage timings TM1 and TM2 is larger than the intensity at the other storage timings TM3 to TM6. Therefore, the amount of charges stored in the charge storage unit is likely to be saturated quickly. Therefore, it is necessary to determine the total time at which charges are stored in one frame such that the amount of charges stored in the charge storage unit is not saturated.

On the other hand, the larger the distance to the object OB, the smaller the intensity of the reflected light RL. That is, the intensity of the reflected light RL received at the storage timings TM5 and TM6 is smaller than that at the other storage timings TM1 to TM4. Therefore, in a case where the charges are stored in the charge storage units at the same time as the total time determined to avoid saturation at the storage timings TM1 and TM2, there is a high possibility that the amount of charges becomes insufficient and the calculation accuracy of the distance deteriorates.

As a countermeasure, the distance image processing unit 4 performs control such that the total time at which charges are stored in one frame is larger at the storage timings (for example, the storage timings TM5 and TM6) with a larger difference from the emission timing L than the storage timings (for example, the storage timings TM1 and TM2) with a smaller difference. Accordingly, it is possible to prevent the reflected light RL from being saturated when the reflected light RL is received from the object OB existing at a short distance, and to store enough charges to accurately measure the distance when the reflected light RL is received from the object OB existing at a long distance.

As described above, the distance image capturing device 1 according to the first embodiment includes the light source unit 2, the light receiving unit 3, and the distance image processing unit 4. The distance image processing unit 4 is provided with storage cycles for storing charges in different patterns in one frame. Here, cycles repeated in each sub-frame, specifically, each of “first cycle”, “second cycle”, and “third cycle” is an example of a “storage cycle”. The distance image processing unit 4 performs control such that the charges are stored in each of the charge storage units CS at any of the plurality of storage timings TM1 to TM6 larger than the number (4) of the charge storage units CS, in a plurality of sub-frames. The distance image processing unit 4 performs control such that the total number of times, which is the sum of times the charges are stored in each of the charge storage units CS, becomes the same in one frame. The distance image processing unit 4 performs control such that the time difference between the first storage timing and the second storage timing becomes a time different from the storage time To. The first storage timing is the storage timing TM for storing charges in a specific charge storage unit (for example, charge storage unit CS1) in a specific sub-frame (for example, first sub-frame). The second storage timing is the storage timing TM for storing charges in a specific charge storage unit (for example, charge storage unit CS1) in another sub-frame (for example, the second sub-frame or the third sub-frame) different from the specific sub-frame.

Accordingly, in the distance image capturing device 1 according to the first embodiment, it is possible to perform control such that the charges are stored in each of the charge storage units CS at any of the plurality of storage timings TM1 to TM6 larger than the number (4) of the charge storage units CS, and the measurable distance can be enlarged. In addition, it can be controlled such that the total number of times, which is the sum of times the charges are stored in each of the charge storage units CS, becomes the same in one frame, and it becomes possible to easily specify the charge storage unit CS in which the charges corresponding to the reflected light RL are stored. Further, it can be controlled such that the time difference between the first storage timing and the second storage timing is a time different from the storage time To, and it becomes possible to calculate the distance by not only making a closed measurement in each sub-frame, but also by combining the amount of charges stored in each of the plurality of sub-frames. Therefore, it is not necessary to store the charges in the charge storage unit at the timings (storage timings TM1 to TM6) corresponding to the measurable range and to store the charges of the background light component in the charge storage unit at a timing different from the measurable range. That is, the measurable range can be extended without increasing a time required for measurement.

Further, in the distance image capturing device 1 of the first embodiment, the distance image processing unit 4 performs control such that the total time at which charges are stored in one frame is larger at the storage timings (for example, the storage timings TM5 and TM6) with a larger difference from the emission timing L than the storage timings (for example, the storage timings TM1 and TM2) with a smaller difference. Accordingly, it is possible to prevent the reflected light RL from being saturated when the reflected light RL is received from the object OB existing at a short distance, and to store enough charges to accurately measure the distance when the reflected light RL is received from the object OB existing at a long distance.

### Modification Example of First Embodiment

In the above-described first embodiment, a case where a plurality of sub-frames are provided in one frame and the storage period and the readout period are provided in each sub-frame has been described as an example. However, the present disclosure is not limited thereto. A frame configuration may be provided in which only the storage period is provided in each sub-frame and one readout period is provided at the end of one frame. In this case, a signal value corresponding to the total value of the charges stored in each sub-frame is read out. As compared with the case where the readout period is provided for each sub-frame as in the above-described first embodiment, the readout period can be reduced, and measurement can be efficiently performed.

In addition, at least, driving with different storage cycles may be performed in one frame, and the sub-frame may not necessarily be provided. In the present modification example, an example of a case where sub-frames are not provided in one frame and driving having different power storage cycles is performed will be described.

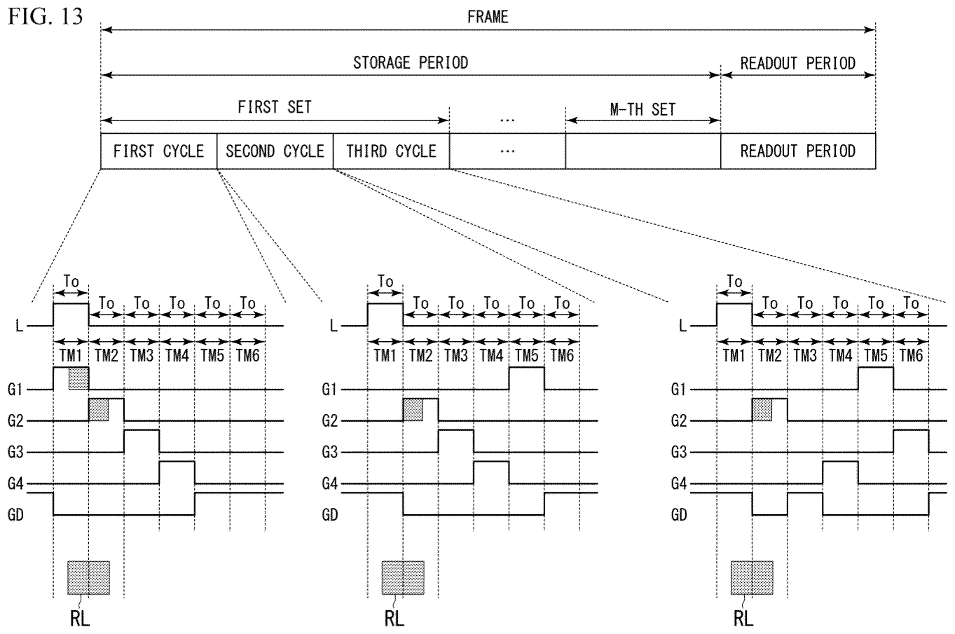

FIGS. 13 to 17 are timing charts showing a timing for driving the pixel 321 according to the modification example of the first embodiment. FIGS. 13 to 17 show the same timing chart, and show examples in which the reflected light RL is received at different timings in the same timing chart.

Specifically, an example is shown in which sets (first set, second set, . . . , M-th set. M is any natural number) of sequentially performing driving having different power storage cycles are provided in one frame. In the set here, driving according to each of “first cycle”, “second cycle”, and “third cycle” is performed. Here, the “first cycle” is the same as the first cycle in FIG. 4, the “second cycle” is the same as the second cycle in FIG. 5, and the “third cycle” is the same as the third cycle in FIG. 6.

FIGS. 13 to 17 show examples in which the reflected light RL is received at different timings in the same timing chart.

FIG. 13 shows an example in which the charges corresponding to the reflected light RL are stored across the storage timings TM1 and TM2.

In this case, in the first cycle, charges corresponding to the first half portion of the reflected light RL are stored in the gate G1, that is, the charge storage unit CS1. In addition, in the first cycle, charges corresponding to the second half portion of the reflected light RL are stored in the gate G2, that is, the charge storage unit CS2. In addition, in the second cycle, charges corresponding to the second half portion of the reflected light RL are stored in the gate G2, that is, the charge storage unit CS2. In addition, in the third cycle, charges corresponding to the second half portion of the reflected light RL are stored in the gate G2, that is, the charge storage unit CS2.

In addition, in each cycle (first cycle, second cycle, and third cycle), the charges corresponding to the background light component are stored once per cycle in each of the charge storage units CS1 to CS4.

That is, when the distance image processing unit 4 performs driving for the storage period in one frame, the charges corresponding to sum of the light amounts of the first half portion of the reflected light RL for one time and the background light component for three times are stored in the charge storage unit CS1. The distance image processing unit 4 reads out the storage signal SIG1 during the readout period, after the storage period ends. The storage signal SIG1 has a signal value corresponding to the light amounts of the first half portion of the reflected light RL for one time and the background light component for three times.

Further, when the distance image processing unit 4 performs driving for the storage period in one frame, the charges corresponding to sum of the light amounts of the second half portion of the reflected light RL for three times and the background light component for three times are stored in the charge storage unit CS2. The distance image processing unit 4 reads out the storage signal SIG2 during the readout period, after the storage period ends. The storage signal SIG2 has a signal value corresponding to the sum of the light amounts of the second half portion of the reflected light RL for three times and the background light component for three times.

Further, when the distance image processing unit 4 performs driving for the storage period in one frame, the charges corresponding to the light amount of the background light component for three times are stored in the charge storage unit CS3. The distance image processing unit 4 reads out the storage signal SIG3 during the readout period, after the storage period ends. The storage signal SIG3 has a signal value corresponding to the sum of the light amounts of the background light component for three times.

Further, when the distance image processing unit 4 performs driving for the storage period in one frame, the charges corresponding to the light amount of the background light component for three times are stored in the charge storage unit CS4. The distance image processing unit 4 reads out the storage signal SIG4 during the readout period, after the storage period ends. The storage signal SIG4 has a signal value corresponding to the sum of the light amounts of the background light component for three times.

For example, the distance image processing unit 4 sets a smallest signal value among the storage signals SIG1 to SIG4 as a signal value corresponding to the background light component. For example, the distance image processing unit 4 calculates the signal value SIGH corresponding to the background light component by using Equation (3).

SIGH=MIN(SIG1,SIG2,SIG3,SIG4) (3)
where:

SIGH is a signal value corresponding to a background light component.

SIG1 is a storage signal corresponding to the amount of charges stored in the charge storage unit CS1.

SIG2 is a storage signal corresponding to the amount of charges stored in the charge storage unit CS2.

SIG3 is a storage signal corresponding to the amount of charges stored in the charge storage unit CS3.

SIG4 is a storage signal corresponding to the amount of charges stored in the charge storage unit CS4.

Here, in the present modification example, the number of times the charges are stored in each of the charge storage units CS is set to be the same number of times (three times) in each set. Accordingly, the amount of charges of the background light component stored in each of the charge storage units CS can be made uniform. Therefore, as shown in Equation (3), the signal value SIGH corresponding to the background light component can be calculated by a simple process of obtaining the minimum value.

The distance image processing unit 4 calculates the storage signal SIGR1 corresponding to the first half portion of the reflected light RL for one time by subtracting the signal value SIGH from the storage signal SIG1 In addition, the distance image processing unit 4 calculates the storage signal SIGR2 corresponding to the second half portion of the reflected light RL for three times by subtracting the signal value SIGH from the storage signal SIG2.

The distance image processing unit 4 corrects the storage signals SIGR1 and SIGR2, and calculates the corrected storage signals SIGR1 # and SIGR2 # corresponding to the reflected light RL for the same number of times. For example, the distance image processing unit 4 calculates the corrected storage signals SIGR1 # and SIGR2 # by using Equation (4).

SIGR1#=SIGR1×3

SIGR2#=SIGR2×1 (4)
where:

SIGR1 # is a corrected storage signal corresponding to the first half portion of the reflected light RL.

SIGR2 # is a corrected storage signal corresponding to the second half portion of the reflected light RL.

The distance image processing unit 4 calculates the distance d to the object OB by substituting the storage signals SIGR1 #, SIGR2 #, and SIGH into, for example. Equation (5).

d=c0×(1/2×Td)

Td=To×(SIGR2#)/(SIGR1#+SIGR2#) (5)
where:

d is the distance to the object OB.

c0 is the speed of light.

Td is the time required for the light to reach the object OB.

SIGR1 # is a corrected storage signal corresponding to the first half portion of the reflected light RL.

SIGR2 # is a corrected storage signal corresponding to the second half portion of the reflected light RL.

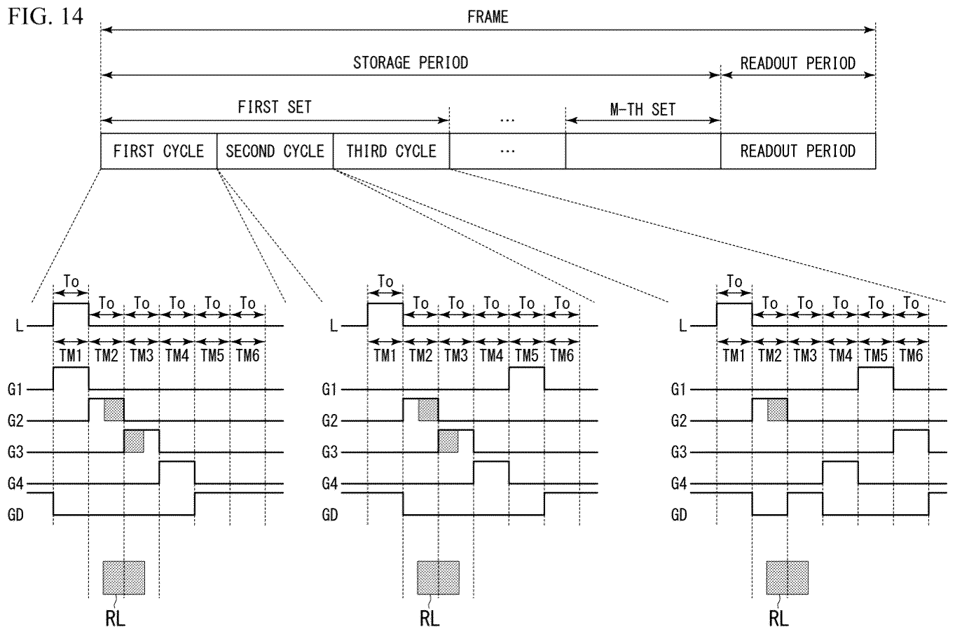

FIG. 14 shows an example in which the charges corresponding to the reflected light RL are stored across the storage timings TM2 to TM3. In this case, the storage signal SIG1 has a signal value corresponding to the light amount of the background light component for three times. The storage signal SIG2 has a signal value corresponding to the light amounts of the first half portion of the reflected light RL for three times and the background light component for three times. The storage signal SIG3 has a signal value corresponding to the light amounts of the second half portion of the reflected light RL for two times and the background light component for three times. The storage signal SIG4 has a signal value corresponding to the light amount of the background light component for three times.

The distance image processing unit 4 calculates the signal value SIGH corresponding to the background light component by using Equation (3).

The distance image processing unit 4 calculates the storage signal SIGR2 corresponding to the first half portion of the reflected light RL for three times by subtracting the signal value SIGH from the storage signal SIG2. In addition, the distance image processing unit 4 calculates the storage signal SIGR3 corresponding to the second half portion of the reflected light RL for two times by subtracting the signal value SIGH from the storage signal SIG3.

The distance image processing unit 4 corrects the storage signals SIGR2 and SIGR3. For example, the distance image processing unit 4 calculates the corrected storage signals SIGR2 # and SIGR3 # by using Equation (6).

SIGR2#=SIGR2×1

SIGR3#=SIGR3×3/2 (6)
where:

SIGR2 # is a corrected storage signal corresponding to the first half portion of the reflected light RL.

SIGR3 # is a corrected storage signal corresponding to the second half portion of the reflected light RL.

SIGR2 is a storage signal corresponding to the first half portion of the reflected light RL.

SIGR3 is a storage signal corresponding to the second half portion of the reflected light RL.

The distance image processing unit 4 calculates the distance d to the object OB by substituting the storage signals SIGR2 #, SIGR3 #, and SIGH into, for example. Equation (7).

d=c0×(1/2×Td)

Td=To×(SIGR3#)/(SIGR2#+SIGR3#) (7)
where:

d is the distance to the object OB.

c0 is the speed of light.

Td is the time required for the light to reach the object OB.

SIGR2 # is a corrected storage signal corresponding to the first half portion of the reflected light RL.

SIGR3 # is a corrected storage signal corresponding to the second half portion of the reflected light RL.

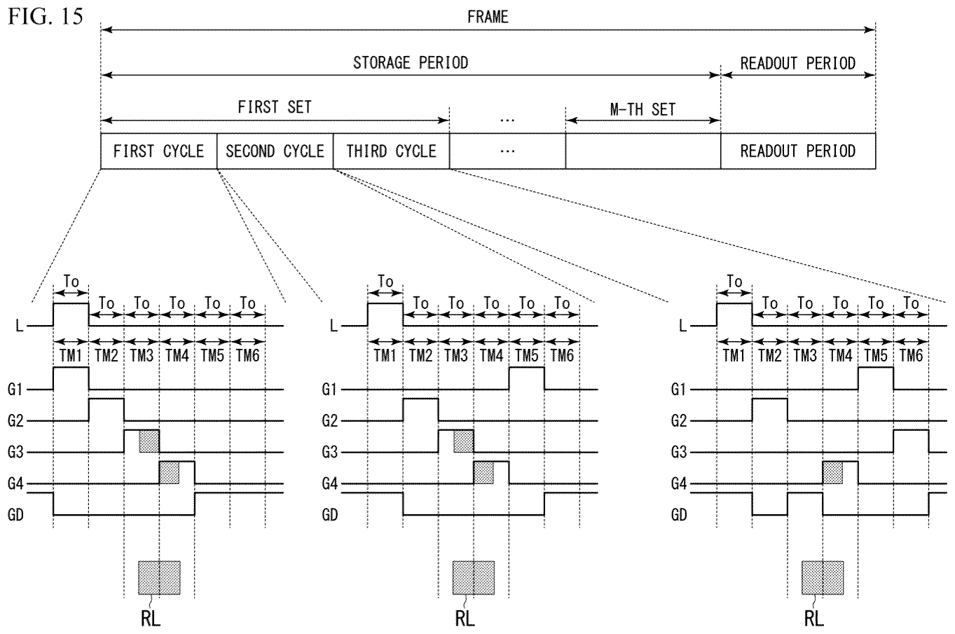

FIG. 15 shows an example in which the charges corresponding to the reflected light RL are stored across the storage timings TM3 to TM4. In this case, the storage signal SIG1 has a signal value corresponding to the light amount of the background light component for three times. The storage signal SIG2 has a signal value corresponding to the light amount of the background light component for three times. The storage signal SIG3 has a signal value corresponding to the light amounts of the first half portion of the reflected light RL for two times and the background light component for three times. The storage signal SIG4 has a signal value corresponding to the light amounts of the second half portion of the reflected light RL for three times and the background light component for three times.

The distance image processing unit 4 calculates the signal value SIGH corresponding to the background light component by using Equation (3).

The distance image processing unit 4 calculates the storage signal SIGR3 corresponding to the first half portion of the reflected light RL for two times by subtracting the signal value SIGH from the storage signal SIG3. In addition, the distance image processing unit 4 calculates the storage signal SIGR4 corresponding to the second half portion of the reflected light RL for three times by subtracting the signal value SIGH from the storage signal SIG4.

The distance image processing unit 4 corrects the storage signals SIGR3 and SIGR4. For example, the distance image processing unit 4 calculates the corrected storage signals SIGR3 # and SIGR4 # by using Equation (8).

SIGR3#=SIGR3×3/2

SIGR4#=SIGR4×1 (8)
where:

SIGR3 # is a corrected storage signal corresponding to the first half portion of the reflected light RL.

SIGR4 # is a corrected storage signal corresponding to the second half portion of the reflected light RL.

SIGR3 is a storage signal corresponding to the first half portion of the reflected light RL.

SIGR4 is a storage signal corresponding to the second half portion of the reflected light RL.

The distance image processing unit 4 calculates the distance d to the object OB by substituting the storage signals SIGR3 #, SIGR4 #, and SIGH into, for example. Equation (9).

d=c0×(1/2×Td)

Td=To×(SIGR4#)/(SIGR3#+SIGR4#) (9)

where:

d is the distance to the object OB.

c0 is the speed of light.

Td is the time required for the light to reach the object OB.

SIGR3 # is a corrected storage signal corresponding to the first half portion of the reflected light RL.

SIGR4 # is a corrected storage signal corresponding to the second half portion of the reflected light RL.

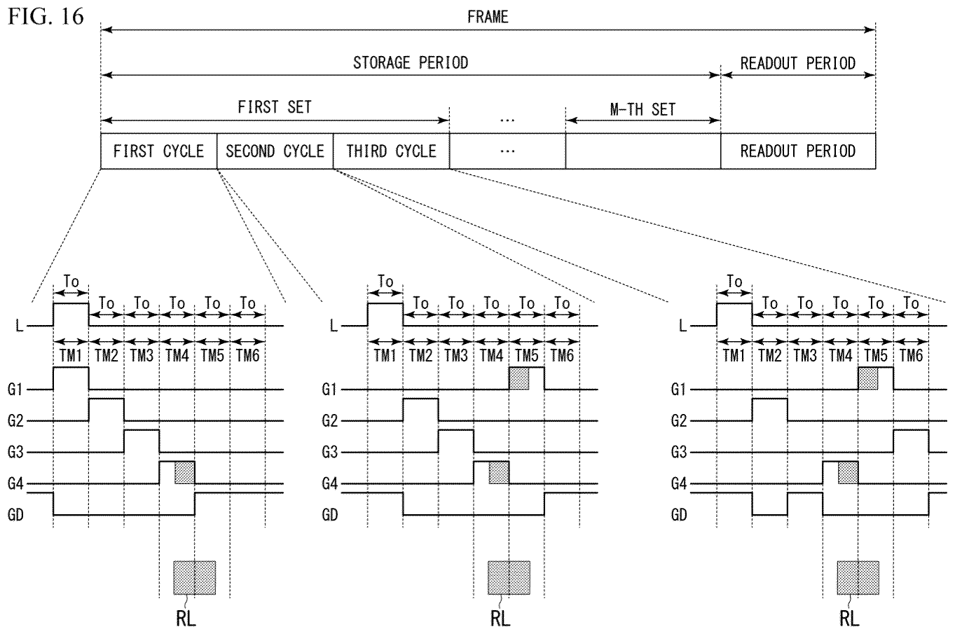

FIG. 16 shows an example in which the charges corresponding to the reflected light RL are stored across the storage timings TM4 to TM5. In this case, the storage signal SIG1 has a signal value corresponding to the light amounts of the second half portion of the reflected light RL for two times and the background light component for three times. The storage signal SIG2 has a signal value corresponding to the light amount of the background light component for three times. The storage signal SIG3 has a signal value corresponding to the light amount of the background light component for three times. The storage signal SIG4 has a signal value corresponding to the light amounts of the first half portion of the reflected light RL for three times and the background light component for three times.

The distance image processing unit 4 calculates the signal value SIGH corresponding to the background light component by using Equation (3).

The distance image processing unit 4 calculates the storage signal SIGR4 corresponding to the first half portion of the reflected light RL for three times by subtracting the signal value SIGH from the storage signal SIG4. In addition, the distance image processing unit 4 calculates the storage signal SIGR1 corresponding to the second half portion of the reflected light RL for two times by subtracting the signal value SIGH from the storage signal SIG1.

The distance image processing unit 4 corrects the storage signals SIGR4 and SIGR1. For example, the distance image processing unit 4 calculates the corrected storage signals SIGR4 # and SIGR1 # by using Equation (10).

SIGR4#=SIGR4×1

SIGR1#=SIGR1×3/2 (10)
where:

SIGR4 # is a corrected storage signal corresponding to the first half portion of the reflected light RL.

SIGR1 # is a corrected storage signal corresponding to the second half portion of the reflected light RL.

SIGR4 is a storage signal corresponding to the first half portion of the reflected light RL.

SIGR1 is a storage signal corresponding to the second half portion of the reflected light RL.

The distance image processing unit 4 calculates the distance d to the object OB by substituting the storage signals SIGR4 #, SIGR1 #, and SIGH into, for example, Equation (11).

d=c0×(1/2×Td)

Td=To×(SIGR1#)/(SIGR4#+SIGR1#) (11)
where:

d is the distance to the object OB.

c0 is the speed of light.

Td is the time required for the light to reach the object OB.

SIGR4 # is a corrected storage signal corresponding to the first half portion of the reflected light RL.

SIGR1 # is a corrected storage signal corresponding to the second half portion of the reflected light RL.

SIGH is a storage signal corresponding to the background light component.

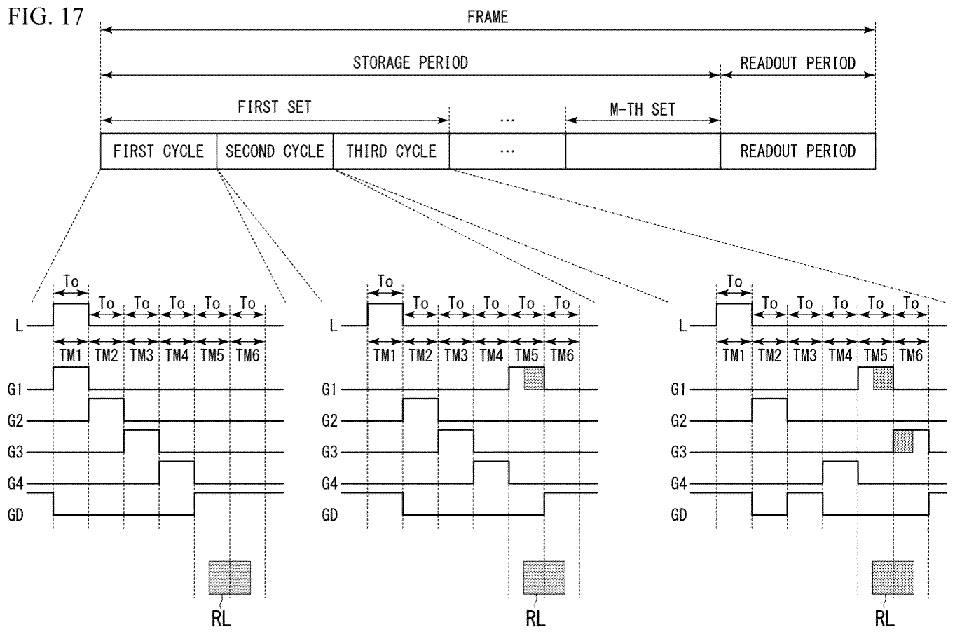

FIG. 17 shows an example in which the charges corresponding to the reflected light RL are stored across the storage timings TM5 to TM6. In this case, the storage signal SIG1 has a signal value corresponding to the light amounts of the first half portion of the reflected light RL for two times and the background light component for three times. The storage signal SIG2 has a signal value corresponding to the light amount of the background light component for three times. The storage signal SIG3 has a signal value corresponding to the light amounts of the second half portion of the reflected light RL for one time and the background light component for three times. The storage signal SIG4 has a signal value corresponding to the light amount of the background light component for three times.

The distance image processing unit 4 calculates the signal value SIGH corresponding to the background light component by using Equation (3).

The distance image processing unit 4 calculates the storage signal SIGR1 corresponding to the first half portion of the reflected light RL for two times by subtracting the signal value SIGH from the storage signal SIG1. In addition, the distance image processing unit 4 calculates the storage signal SIGR3 corresponding to the second half portion of the reflected light RL for one time by subtracting the signal value SIGH from the storage signal SIG3.

The distance image processing unit 4 corrects the storage signals SIGR1 and SIGR3. For example, the distance image processing unit 4 calculates the corrected storage signals SIGR1 # and SIGR3 # by using Equation (12).

SIGR1#=SIGR1×3/2

SIGR3#=SIGR3×3 (12)
where:

SIGR1 # is a corrected storage signal corresponding to the first half portion of the reflected light RL.

SIGR3 # is a corrected storage signal corresponding to the second half portion of the reflected light RL.

SIGR1 is a storage signal corresponding to the first half portion of the reflected light RL.

SIGR3 is a storage signal corresponding to the second half portion of the reflected light RL.

The distance image processing unit 4 calculates the distance d to the object OB by substituting the storage signals SIGR1 #. SIGR3 #, and SIGH into, for example, Equation (13).

d=c0×(1/2×Td)

Td=To×(SIGR3#)/(SIGR1#+SIGR3#) (13)
where:

d is the distance to the object OB.

c0 is the speed of light.

Td is the time required for the light to reach the object OB.

SIGR1 # is a corrected storage signal corresponding to the first half portion of the reflected light RL.

SIGR3 # is a corrected storage signal corresponding to the second half portion of the reflected light RL.

The correction coefficients shown in Equations (4), (6), (8), (10), and (12) are examples, and are not limited thereto. Through the correction, at least each of the storage signals corresponding to the first half portion and the second half portion of the reflected light RL may be corrected to a storage signal corresponding to the same number of times. For example, in Equation (3), SIGR1 may be multiplied by “1”, and SIGR2 may be multiplied by “1/3”.

As described above, in the distance image capturing device 1 according to the modification example of the first embodiment, the distance image processing unit 4 is provided with storage cycles for storing charges in different patterns in one frame. Here, cycles repeated in each sub-frame, specifically, each of “first cycle”, “second cycle”, and “third cycle” is an example of a “storage cycle”. The distance image processing unit 4 controls the storage cycle such that the charges are stored in each of the charge storage units CS at any of the plurality of storage timings TM1 to TM6 larger than the number (4) of the charge storage units CS, in one frame. The distance image processing unit 4 performs control such that the total number of times, which is the sum of times the charges are stored in each of the charge storage units CS, becomes the same in one frame. The distance image processing unit 4 performs control such that the time difference between the first storage timing and the second storage timing becomes a time different from the storage time To. The first storage timing is a timing for storing charges in a specific charge storage unit (for example, charge storage unit CS1) in a specific cycle (for example, first cycle). The second storage timing is a timing for storing charges in a specific charge storage unit (for example, charge storage unit CS1) in another cycle (for example, second cycle or third cycle) different from the specific cycle.

Accordingly, in the distance image capturing device 1 according to the modification example of the first embodiment, it is possible to perform control such that the charges are stored in each of the charge storage units CS at any of the plurality of storage timings TM1 to TM6 larger than the number (4) of the charge storage units CS, and the measurable distance can be enlarged. In addition, it can be controlled such that the total number of times, which is the sum of times the charges are stored in each of the charge storage units CS becomes the same in one frame, the storage signal corresponding to the background light component can be easily calculated, and it becomes possible to easily specify the charge storage unit CS in which the charges corresponding to the reflected light RL are stored. Further, it can be controlled such that the time difference between the first storage timing and the second storage timing is a time different from the storage time To, and it becomes possible to calculate the distance by using a storage signal corresponding to the amount of charges stored over one frame. Therefore, the same effect as in the above-described embodiment is obtained.

### Second Embodiment

Here, a second embodiment will be described. The present embodiment differs from the previous embodiment in an aspect of including a plurality of measurement modes. The plurality of measurement modes include at least a “normal mode” and a “wide range mode”.

Although the normal mode measures a distance to the object OB existing at a close distance, the normal mode is a mode that does not measure the distance to the object OB existing at a far distance. Although the normal mode stores charges corresponding to the received reflected light RL from the object OB existing at the close distance to the charge storage unit CS, pixels 321 are driven such that the normal mode does not store charges corresponding to the received reflected light RL from the object OB existing at the far distance to the charge storage unit CS.

The normal mode, as a breakdown of one frame, is for example a mode where the pixels 321 are driven by only repeatedly executing the first sub-frame shown in FIG. 4. In FIG. 4, although charges are stored at each timing of the timings TM1 to TM4, the pixels 321 are driven such that no charges are stored at neither timing of the storage timings TM5 nor TM6. The storage timings TM1 to TM4 are an example of timings where charges corresponding to the received reflected light RL from the object OB existing at the close distance are stored to the charge storage unit CS. The storage timings TM5 and TM6 are an example timings where charges corresponding to the received reflected light RL from the object OB existing at the far distance are stored to the charge storage unit CS.

The wide range mode is a measurement mode that measures a distance to the object OB existing in the wide range from the close distance to the far distance. In the wide range mode, the pixels 321 are driven so that charges corresponding to the received reflected light RL from the object OB existing at either the close distance or the object OB existing at the far distance are stored to the charge storage units CS.

The wide range mode, as a breakdown of one frame, is for example a mode where the pixels 321 are driven by repeatedly executing the first sub-frame to the third sub-frame shown in FIG. 4 to FIG. 6. In FIG. 4, the pixels 321 are driven so that charges are stored at each timing of the storage timings TM1 to TM4. In FIG. 5, the pixels 321 are driven so that charges are stored in each of the charge storage units CS2 to CS5 at each of the storage timings TM2 to TM5. In FIG. 6, the pixels 321 are driven so that charges are stored in each of the charge storage units CS2, CS4, CS1, and CS3 at each of the storage timings TM2, and TM4 to TM6.

In other words, as a breakdown of one frame, the wide range mode is, for example, a mode where the pixels 321 are driven by repeatedly executing the first sub-frame to the third sub-frame shown in FIG. 9 to FIG. 11. In FIG. 9, the pixels 321 are driven so that charges are stored at each timing of the storage timings TM1 to TM2, and TM5 to TM6. In FIG. 10 and FIG. 11, the pixels 321 are driven so that charges are stored at each timing of the storage timings TM3 to TM6.

In this manner, in the wide range mode, the pixels 321 are driven so as to store charges corresponding to the received reflected light RL from the object OB to the charge storage units CS at the storage timings TM1 to TM4 that correspond to the close distance, and either of the storage timings TM5 and TM6 that correspond to the to the far distance. Accordingly, it is possible to measure a distance of the object OB existing in the wide range from the close distance to the far distance.

In the present embodiment, the distance image processing unit 4 calculates a statistical amount of pixel values (distance values) for each of the pixels 321 that make up the distance image captured (measured) by the distance image capturing device 1. The statistical amount here may be the statistical amount calculated by using any optional statistical method. The statistical amount, for example, may be any of a frequency distribution, a average value, a median, a variance, a standard deviation, a mode, a maximum value, or a minimum value or the like, or a combination thereof. In a case where the distance image processing unit 4 based on the calculated statistical amount determines that the object OB exists in the wide range from the close distance to the far distance, a next measurement mode at the next measurement is set to the wide range mode. On the other hand, in a case where the distance image processing unit 4 based on the calculated statistical amount determines that the object OB only exists in the close distance, the measurement mode at the next measurement is set to the normal mode.

As the statistical amount for example, the distance image processing unit 4 calculates the minimum value and a measurement range. The minimum value is a minimum distance value that is measured at the distance image. The measurement range is a range from the minimum distance value to a maximum distance value measured at the distance image. The distance image processing unit 4 determines that the object OB exists in the wide range from the close distance to the far distance, in a case where the minimum value calculated based on the distance image is less than a first threshold value, and the measured range is greater than or equal to a second threshold value. The first threshold value is a value that is set corresponding to a distance that is viewed as the close distance. The second threshold value is a value that is set corresponding to a distance range that is viewed as the wide range. In a case where the object OB is determined to exist in the wide range, the distance image processing unit 4 sets the measurement mode at the next measurement to the wide range mode. On the other hand, the distance image processing unit 4 determines that the object OB only exists in the close distance, in a case where the minimum value is less than a first threshold value, and the measured range is less than a second threshold value. In a case where the distance image processing unit 4 determines that the object OB only exists in the close distance, the measurement mode at the next measurement is set to the normal mode.

In other words, as the statistical amount, the distance image processing unit 4 calculates the maximum value. The maximum value is a maximum distance value that is measured at the distance image. The distance image processing unit 4 determines that the object OB exists in the far distance, in a case where the maximum value calculated based on the distance image is greater than or equal to a third threshold value. The third threshold value is a value that is set corresponding to a distance that is viewed as the far distance. In a case where the object OB is determined to exist in the far distance, the distance image processing unit 4 sets the measurement mode at the next measurement to the wide range mode. On the other hand, when the maximum value is less than the third threshold value, the distance image processing unit 4 determines that the object OB only exists in the close distance. In a case where the object OB is determined to only exist in the close distance, the distance image processing unit 4 sets the measurement mode at the next measurement to the normal mode.

The distance image processing unit 4 may set the measurement mode at the next measurement to the wide range mode, in a case where there are any changes during measurement in the normal mode. In this case, the distance image processing unit 4 first begins capturing (measuring) in the normal mode, calculates the statistical amount for each measurement, and stores the calculated statistical amounts. If a difference between the calculated statistical amount measured in a present measurement and calculated statistical amount measured in a previous measurement is greater than a fourth threshold value, the measurement mode at the next measurement is set to the wide range mode. The fourth threshold value is a value that is set corresponding to a value which is viewed as having a change occur, and is a value that is set according to the statistical amount. In cases such as a case where the object OB ceases to exist in the measurement space, by changing the measurement mode in a case where there are any changes during measurement, it is possible to determine whether or not the object OB exists in the measurable range (far range) of the wide range mode. For example, the distance image processing unit 4 continues measurement in the wide range mode in a case where the object OB exists in the far distance, and continues measurement in the normal mode in a case where the object OB does not exist in the measurement space of the wide range mode that includes the far distance.

As explained above, the distance image capturing device 1 of the second embodiment contains a plurality of measurement modes that include the normal mode and the wide range mode. Although the normal mode is a mode that measures the distance to the object OB existing at the close distance, the normal mode does not measure the distance to the object OB existing at the far distance. The wide range mode is a mode that measures the distance to the object OB existing in the wide range from the close distance to the far distance. The distance image processing unit 4 calculates the statistical amount of each pixel value (distance value) of the pixels 321. The distance image processing unit 4 determines the measurement mode at the next measurement to be either the normal mode or the wide range mode based on the calculated statistical amount.

Accordingly, in the distance image capturing device 1 according to the second embodiment, it is possible to switch between measurement modes according to a state of existence of the object OB in the measurement space without increasing a time required for measurement. For example, in a state where the object OB only exists in the close distance, the measurement is conducted in the normal mode, and the distance to the object OB existing at the far distance is not measured, making it possible to shorten the time required compared to a case where the measurement is conducted in the wide range mode. On the other hand, in a state where the object OB exists in the wide range from the close distance to the far distance, the measurement is conducted in the wide range mode, and it is possible to measure the distance of each objects OB existing in the wide range. Also, it is possible to shorten the time required for the measurement compared to a case where the charges of the background light component in the charge storage unit CS are stored at a timing different from the measurable range.

### Modification Example of the Second Embodiment

Here, a modification example of the second embodiment is explained. The present modification example differs from the previously mentioned second embodiment in an aspect of setting a measurement mode for each pixilation area. Pixilation areas are regions (areas) of the plurality of pixels 321, provided in the distance image sensor 32, that are split into pixel groups which are made of the plurality of the pixels 321 that are adjacent. For example, it is possible to provide four pixilation areas by splitting the pixel groups disposed in the two dimensional matrix of eight rows by eight columns in the distance image sensor 32 of FIG. 2 into four In this case, each pixilation area includes sixteen pixels formed from four rows by four columns. The pixilation area is not limited to four rows by four columns, and may be set freely. The pixilation area for example made of twenty five pixels formed from five rows by five columns may be provided, or a pixilation area made of ten pixels formed from two rows by five columns may be provided.

In the present embodiment, the distance image processing unit 4 calculates a statistical amount of pixel values (distance values) for each of the pixels 321 that configures the pixilation area. The distance image processing unit 4 determines whether the measurement mode at the next measurement is the normal mode or the wide range mode for each pixilation area, based on the calculated statistical amounts.

A method for determining either of the normal mode or the wide range mode by the distance image processing unit 4 is the same as previously mentioned in the second embodiment. Specifically, the distance image processing unit 4 calculates the pixel value (distance value) of each of the pixels 321 that configure the pixilation area for each of the pixilation areas. In a case where it is determined that the object OB exists in the wide range from the close distance to the far distance, the distance image processing unit 4 makes the measurement mode of the said pixilation area be the wide range mode, in the space of the measured distance by the said pixilation area, based on the statistical amount of each of the pixilation areas. On the other hand, in a case where it is determined that the object OB only exists in the close distance in the space measured by the said pixilation area, the distance image processing unit 4 makes the measurement mode at the next measurement be the normal mode, based on the statistical amount of each of the pixilation areas.

As explained above, the distance image processing unit 4 calculates the statistical amount of each pixel value (distance value) of the pixels 321 for each pixilation area in the distance image capturing device 1 according to the modification example of the second embodiment. The distance image processing unit 4 determines the measurement mode at the next measurement to either be the normal mode or the wide range mode for each pixilation area based on the statistical amount calculated for each pixilation area. Accordingly, it is possible to determine the measurement mode for each pixilation area in the distance image capturing device 1 according to the modification example of the second embodiment. Therefore, in a state where only the distance up to where the object OB existing in the wide range is measured, it is possible to correspond by only measuring the pixilation area corresponding to the one part measured in the wide range mode.

All or a part of the distance image capturing device 1 and the distance image processing unit 4 in the above-described embodiment may be implemented by a computer. In that case, a program for implementing this function may be recorded on a computer-readable recording medium, and the program recorded on the recording medium may be read and executed by a computer system to implement the reporting device. The term “computer system” as used herein includes an OS and hardware such as peripheral devices. Further, the “computer-readable recording medium” refers to a portable medium such as a flexible disk, a magneto-optical disk, a ROM, or a CD-ROM, or a storage device such as a hard disk built in a computer system. Further, a “computer-readable recording medium” may include those which dynamically hold programs for a short period of time, such as a communication line when a program is transmitted via a network such as the Internet or a communication line such as a telephone line, or those which hold programs for a certain period of time, such as a volatile memory inside a computer system that serves as a server or client in that case.

Further, the above program may be for implementing a part of the above-described functions, may be for implementing the above-described functions in combination with a program already recorded in the computer system, or may be implemented by using a programmable logic device such as FPGA.

Although the embodiments of the present disclosure have been described in detail with reference to the drawings, the specific configuration is not limited to these embodiments, and design, device configuration, correction processing, filtering processing, and the like are included within the scope not departing the gist of the present disclosure.

While preferred embodiments of the invention have been described and illustrated above, it should be understood that these are exemplary of the invention and are not to be considered as limiting. Additions, omissions, substitutions, and other modifications can be made without departing from the scope of the invention.

Accordingly, the invention is not to be considered as being limited by the foregoing description and is only limited by the scope of the appended claims.

### EXPLANATION OF REFERENCES

1: distance image capturing device
2: light source unit
3: light receiving unit
32: distance image sensor
321: pixel
323 vertical scanning circuit
4: distance image processing unit
41: timing control unit
42: distance calculation unit
43: measurement control unit
CS: charge storage unit
PO: optical pulse

What is claimed is:

1. A distance image capturing device comprising:
a light source unit that irradiates a measurement space with a light pulse;
a light receiving unit having a pixel including a photoelectric conversion element that generates charges according to incident light and a plurality of charge storage units that store the charges, and a pixel drive circuit that distributes the charges to the charge storage units and stores the charges in each of the charge storage units at a predetermined storage timing synchronized with an emission timing of emitting the light pulse; and
a distance image processing unit that calculates a distance to an object existing in the measurement space, based on an amount of the charges stored in each of the charge storage units, wherein
the distance image processing unit
provides a plurality of storage cycles in one frame,
performs control such that in the plurality of storage cycles, the charges are stored in each of the charge storage units at any timing among storage timings of which the number is larger than a number of the charge storage units included in the pixel,
performs control such that a total number of times, which is a sum of times the charges are stored in each of the charge storage units, becomes the same in the one frame, and
performs control such that a time difference between a first storage timing and a second storage timing is a time different from a storage time for storing the charges in each of the charge storage units, the first storage timing being a storage timing for storing the charges in a specific charge storage unit among the plurality of charge storage units in a specific storage cycle among the plurality of storage cycles, and the second storage timing being a storage timing for storing the charges in the specific charge storage unit in another storage cycle different from the specific storage cycle.

2. The distance image capturing device according to claim 1, wherein
the distance image processing unit performs control such that a total time at which the charges are stored in the one frame is larger at the storage timings with a larger difference from the emission timing than the storage timings with a smaller difference.

3. The distance image capturing device according to claim 1, wherein
a plurality of measurement modes that include:
a normal mode, and
a wide range mode,
the normal mode is a mode that measures a distance to the object existing at a close distance, and does not measure a distance to the object existing at a far distance,
the wide range mode is a mode that measures a distance to the object existing in a wide range from the close distance to the far distance,
the distance image processing unit calculates a statistical amount of pixel values for each of the pixels that configures a distance image, and determines whether a measurement mode at a next measurement is the normal mode or the wide range mode, based on the calculated statistical amount.

4. A distance image capturing method performed by a distance image capturing device including a light source unit that irradiates a measurement space with a light pulse; a light receiving unit having a pixel including a photoelectric conversion element that generates charges according to incident light and a plurality of charge storage units that store the charges, and a pixel drive circuit that distributes the charges to the charge storage units and stores the charges in each of the charge storage units at a predetermined storage timing synchronized with an emission timing of emitting the light pulse; and a distance image processing unit that calculates a distance to an object existing in the measurement space, based on an amount of the charges stored in each of the charge storage units, the method comprising:
via the distance image processing unit
providing a plurality of storage cycles in one frame;
performing control such that in the plurality of storage cycles, the charges are stored in each of the charge storage units at any timing among storage timings of which the number is larger than a number of the charge storage units included in the pixel;
performing control such that a total number of times, which is a sum of times the charges are stored in each of the charge storage units, becomes the same in the one frame; and
performing control such that a time difference between a first storage timing and a second storage timing is a time different from a storage time for storing the charges in each of the charge storage units, the first storage timing being a storage timing for storing the charges in a specific charge storage unit among the plurality of charge storage units in a specific storage cycle among the plurality of storage cycles, and the second storage timing being a storage timing for storing the charges in the specific charge storage unit in another storage cycle different from the specific storage cycle.
